(19) United States
(12) Patent Application Publication
(10) Pub. No.: US 2026/0231135 A1
(43) Pub. Date: Aug. 6, 2026

(54) BASE STATION, USER EQUIPMENT, CIRCUITRY AND METHOD FOR BEAM MANAGEMENT

(71) Applicant: Sony Group Corporation, Tokyo (JP)

(72) Inventors: Yuxin WEI, Basingstoke (GB); Vivek SHARMA, Surrey (GB); Hideji WAKABAYASHI, Hampshire (GB); Yassin Aden AWAD, Uxbridge (GB)

(73) Assignee: Sony Group Corporation, Tokyo (JP)

(21) Appl. No.: 19/150,204

(22) PCT Filed: Feb. 27, 2024
(86) PCT No.: PCT/EP2024/054964

§ 371 Date: Jul. 23, 2025

(30) Foreign Application Priority Data
Feb. 27, 2023 (EP) 23158822.9

(51) Int. Cl. H04W 72/044

(52) U.S. Cl. CPC H04W 72/046

(57) ABSTRACT

The disclosure pertains to a base station for a mobile telecommunications system, wherein the base station includes circuitry that is configured to: obtain candidate beam information for a user equipment of the mobile telecommunications system, wherein the candidate beam information is generated by a machine learning model and indicates a candidate beam for beam level mobility of the user equipment; and configure the candidate beam for communication with the user equipment according to the candidate beam information.

### TECHNICAL FIELD

The present disclosure generally pertains to a base station, a user equipment, a circuitry and a method, in particular, to a base station, a user equipment, a circuitry and a method for a mobile telecommunications system.

### TECHNICAL BACKGROUND

Several generations of mobile telecommunications systems are known, e.g., the third generation (3G), which is based on the International Mobile Telecommunications-2000 (IMT-2000) specifications, the fourth generation (4G), which provides capabilities as defined in the International Mobile Telecommunications-Advanced Standard (IMT-Advanced Standard), and the current fifth generation (5G), which has recently been put into practice and which is still being developed further.

A wireless communication technology that provides the requirements of 5G is termed New Radio (NR) Access Technology. Some aspect of NR is based on Long Term Evolution (LTE) technology, which is a wireless communications technology allowing high-speed data communications for mobile phones and data terminals, and which is already used for 4G mobile telecommunications systems. LTE and NR are standardized under the control of 3GPP (3 rd Generation Partnership Project).

NR provides for communication between a user equipment and a base station (gNB) through beams. This includes beam management, such as beam level mobility and beam failure recovery.

Although there exist techniques for beam management, it is generally desirable to provide an improved base station, user equipment, circuitry and method that allow an improved beam management.

### SUMMARY

According to a first aspect, the disclosure provides a base station for a mobile telecommunications system, wherein the base station comprises circuitry configured to: obtain candidate beam information for a user equipment of the mobile telecommunications system, wherein the candidate beam information is generated by a machine learning model and indicates a candidate beam for beam level mobility of the user equipment; and configure the candidate beam for communication with the user equipment according to the candidate beam information.

According to a second aspect, the disclosure provides a user equipment for a mobile telecommunications system, wherein the user equipment comprises circuitry configured to: obtain candidate beam information for the user equipment, wherein the candidate beam information is generated by a machine learning model and indicates a candidate beam for beam level mobility of the user equipment; and configure the candidate beam for communication with a base station of the mobile telecommunications system according to the candidate beam information.

According to a third aspect, the disclosure provides a circuitry for a mobile telecommunications system, wherein the circuitry is configured to: obtain candidate beam information for a user equipment of the mobile telecommunications system, wherein the candidate beam information is generated by a machine learning model and indicates a candidate beam for beam level mobility of the user equipment; and configure the candidate beam for communication with the user equipment according to the candidate beam information.

According to a fourth aspect, the disclosure provides a method for a mobile telecommunications system, the method comprising: obtaining candidate beam information for a user equipment of the mobile telecommunications system, wherein the candidate beam information is generated by a machine learning model and indicates a candidate beam for beam level mobility of the user equipment; and configuring the candidate beam for communication with the user equipment according to the candidate beam information.

According to a fifth aspect, the disclosure provides a method for a user equipment of a mobile telecommunications system, wherein the method comprises: obtaining candidate beam information for the user equipment, wherein the candidate beam information is generated by a machine learning model and indicates a candidate beam for beam level mobility of the user equipment; and configuring the candidate beam for communication with a base station of the mobile telecommunications system according to the candidate beam information.

According to a sixth aspect, the disclosure provides a base station for a mobile telecommunications system, wherein the base station comprises circuitry configured to: receive a measurement report from a user equipment of the mobile telecommunications system; generate, by a machine learning model, candidate beam information for the user equipment, wherein the candidate beam information indicates a candidate beam for beam level mobility of the user equipment and is based on the received measurement report, and transmit to the user equipment a deactivation signal that instructs the user equipment to skip sending a measurement report.

According to a seventh aspect, the disclosure provides a user equipment for a mobile telecommunications system, wherein the user equipment comprises circuitry configured to: transmit a measurement report to a base station of the mobile telecommunications system for generating, by a machine learning model evaluated on a network side of the mobile telecommunications system, candidate beam information for the user equipment, wherein the candidate beam information indicates a candidate beam for beam level mobility of the user equipment and is based on the received measurement report; receive from the base station a deactivation signal that instructs the user equipment to skip sending a measurement report; and skip sending a measurement report according to the deactivation signal.

According to an eighth aspect, the disclosure provides a circuitry for a mobile telecommunications system, wherein the circuitry is configured to: receive a measurement report from a user equipment of the mobile telecommunications system; generate, by a machine learning model, candidate beam information for the user equipment, wherein the candidate beam information indicates a candidate beam for beam level mobility of the user equipment and is based on the received measurement report; and transmit to the user equipment a deactivation signal that instructs the user equipment to skip sending a measurement report.

According to a ninth aspect, the disclosure provides a method for a mobile telecommunications system, wherein the method comprises: receiving a measurement report from a user equipment of the mobile telecommunications system; generating, by a machine learning model, candidate beam information for the user equipment, wherein the candidate beam information indicates a candidate beam for beam level mobility of the user equipment and is based on the received measurement report; and transmitting to the user equipment a deactivation signal that instructs the user equipment to skip sending a measurement report.

According to a tenth aspect, the disclosure provides a method for a user equipment of a mobile telecommunications system, wherein the method comprises: transmitting a measurement report to a base station of the mobile telecommunications system for generating, by a machine learning model evaluated on a network side of the mobile telecommunications system, candidate beam information for the user equipment, wherein the candidate beam information indicates a candidate beam for beam level mobility of the user equipment and is based on the received measurement report; receiving from the base station a deactivation signal that instructs the user equipment to skip sending a measurement report; and skipping sending a measurement report according to the deactivation signal.

According to an eleventh aspect, the disclosure provides a base station for a mobile telecommunications system, wherein the base station comprises circuitry configured to: obtain, from a machine learning model, candidate beam information for a user equipment of the mobile telecommunications system, wherein the candidate beam information indicates a plurality of candidate beams for beam failure recovery of the user equipment; and configure the plurality of candidate beams for the user equipment and a selection condition for selecting a candidate beam of the plurality of candidate beams for beam failure recovery.

According to a twelfth aspect, the disclosure provides a user equipment for a mobile telecommunications system, wherein the user equipment comprises circuitry configured to: obtain, from a machine learning model, candidate beam information for the user equipment, wherein the candidate beam information indicates a plurality of candidate beams for beam failure recovery of the user equipment; and configure the plurality of candidate beams for communication with a base station of the mobile telecommunication system and a selection condition for selecting a candidate beam of the plurality of candidate beams for beam failure recovery.

According to a thirteenth aspect, the disclosure provides a circuitry for a mobile telecommunications system, wherein the circuitry is configured to: obtain, from a machine learning model, candidate beam information for a user equipment of the mobile telecommunications system, wherein the candidate beam information indicates a plurality of candidate beams for beam failure recovery of the user equipment; and configure the plurality of candidate beams for the user equipment and a selection condition for selecting a candidate beam of the plurality of candidate beams for beam failure recovery.

According to a fourteenth aspect, the disclosure provides a method for a mobile telecommunications system, wherein the method comprises: obtaining, from a machine learning model, candidate beam information for a user equipment of the mobile telecommunications system, wherein the candidate beam information indicates a plurality of candidate beams for beam failure recovery of the user equipment; and configuring the plurality of candidate beams for the user equipment and a selection condition for selecting a candidate beam of the plurality of candidate beams for beam failure recovery.

According to a fifteenth aspect, the disclosure provides a method for a user equipment of a mobile telecommunications system, wherein the method comprises: obtaining, from a machine learning model, candidate beam information for the user equipment, wherein the candidate beam information indicates a plurality of candidate beams for beam failure recovery of the user equipment; and configuring the plurality of candidate beams for communication with a base station of the mobile telecommunication system and a selection condition for selecting a candidate beam of the plurality of candidate beams for beam failure recovery.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates a mobile telecommunications system according to an embodiment;

FIG. 2 illustrates a method for beam level mobility with a network-side machine learning model according to an embodiment;

FIG. 3 illustrates a method for skipping a measurement report according to an embodiment;

FIG. 4 illustrates a condition associated with a candidate beam according to an embodiment;

FIG. 5 illustrates a method for beam level mobility with a user-equipment-side machine learning model according to an embodiment;

FIG. 6 illustrates a method for beam failure recovery according to an embodiment;

FIG. 7 illustrates a user equipment and a base station according to an embodiment; and

FIG. 8 illustrates a general-purpose computer according to an embodiment.

### DETAILED DESCRIPTION OF EMBODIMENTS

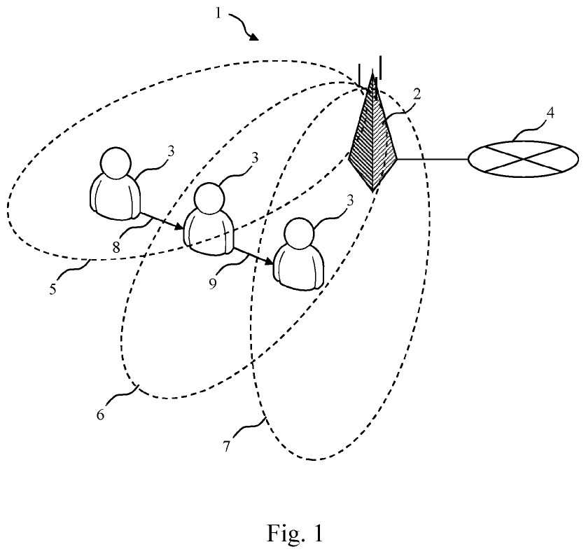

Before a detailed description of the embodiments under reference of FIG. 1 is given, general explanations are made.

As mentioned in the outset, several generations of mobile telecommunications systems are known, e.g., the third generation (3G), which is based on the International Mobile Telecommunications-2000 (IMT-2000) specifications, the fourth generation (4G), which provides capabilities as defined in the International Mobile Telecommunications-Advanced Standard (IMT-Advanced Standard), and the current fifth generation (5G), which has recently been put into practice and which is still being developed further.

A wireless communication technology that provides the requirements of 5G is termed New Radio (NR) Access Technology. Some aspect of NR is based on Long Term Evolution (LTE) technology, which is a wireless communications technology allowing high-speed data communications for mobile phones and data terminals, and which is already used for 4G mobile telecommunications systems. LTE and NR are standardized under the control of 3GPP (3 rd Generation Partnership Project).

NR provides for communication between a user equipment (UE) and a base station (gNB) through beams. This includes beam management, such as beam level mobility and beam failure recovery. Beam level mobility allows switching the communication between the UE and the gNB from a first beam to a second beam, e.g., if a link quality of the first beam deteriorates. Beam failure recovery allows resuming the communication between the UE and the gNB after the communication through a beam has been interrupted.

It has been recognized that artificial intelligence and/or machine learning (AI/ML) may improve beam management. For example, for beam level mobility, an AI/ML model may predict an advantageous time for switching from a first beam to a second beam, e.g., because a link quality of the first beam is expected to deteriorate and/or because a link quality of the second beam is expected to improve. For example, for beam failure recovery, an AI/ML model may predict one or more candidate beams that are expected to have a sufficient link quality for resuming the communication between the UE and the gNB after the communication through a serving beam has failed. Such changes in a link quality of a beam may be caused, e.g., by a movement of the UE.

Accordingly, a study item (SI) on AI/ML for a NR air interface has been approved. Objectives of the SI include beam management as a use case, e.g., beam prediction in time and/or spatial domain for overhead and latency reduction and/or beam selection accuracy improvement. The objectives of the SI also include, as a physical (PHY) layer aspect, a use case and collaboration level specific specification impact, such as new signaling, means for training and validation data assistance, assistance information, measurement and feedback. The objectives of the SI further include protocol aspects related to capability indication, configuration and control procedures (training/inference) and management of data and AI/ML model.

Agreements of the 3GPP Radio Access Network Work Group 1 (RAN 1) on AI/ML for an NR air interface include studying, for a beam management case with a UE-side AI/ML model, a potential specification impact of layer 1 (L1) signaling to report, to a network, information related to AI/ML inference including a beam/beams that is/are based on an output of the AI/ML model inference, a predicted L1 Reference Signal Received Power (RSRP) corresponding to the beam(s) (which is for further study (FFS)) and other information (which is FFS).

The agreements of the 3 GPP RAN 1 further include studying, for a beam management case with a UE-side AI/ML model, a potential specification impact of L1 signaling to report, to the network, information related to AI/ML inference including a beam beams of N future time instance(s) that is/are based on an output of the AI/ML model inference, the value of N (which is FFS), a predicted L1-RSRP corresponding to the beam(s) (which is FFS), information about a timestamp corresponding to the reported beam(s) (wherein it is FFS whether the timestamp is explicit or implicit) and other information (which is FFS).

As a working assumption for cases with a network-side AI/ML model, it has been agreed to study L1 beam reporting enhancements for an AI/ML model inference. The reporting enhancements include that a UE may report measurement results of more than four beams in one reporting instance. Other L1 reporting enhancements may also be considered.

In NR, beam level mobility is specified in TS 38.300 as follows:

“Beam Level Mobility does not require explicit RRC signalling to be triggered. Beam level mobility can be within a cell, or between cells, the latter is referred to as inter-cell beam management (ICBM). For ICBM, a UE can receive or transmit UE dedicated channels/signals via a TRP associated with a PCI different from the PCI of a serving cell, while non-UE-dedicated channels/signals can only be received via a TRP associated with a PCI of the serving cell. The gNB provides via RRC signalling the UE with measurement configuration containing configurations of SSB/CSI resources and resource sets, reports and trigger states for triggering channel and interference measurements and reports. In case of ICBM, a measurement configuration includes SSB resources associated with PCIs different from the PCI of a serving cell. Beam Level Mobility is then dealt with at lower layers by means of physical layer and MAC layer control signalling, and RRC is not required to know which beam is being used at a given point in time.

SSB-based Beam Level Mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.”

In NR, beam failure detection and recovery are specified in TS 38.300 as follows:

“For beam failure detection, the gNB configures the UE with beam failure detection reference signals (SSB or CSI-RS) and the UE declares beam failure when the number of beam failure instance indications from the physical layer reaches a configured threshold before a configured timer expires. For beam failure detection in multi-TRP operation, the gNB configures the UE with two sets of beam failure detection reference signals each associated with a TRP, and the UE declares beam failure for a TRP when the number of beam failure instance indications associated with the corresponding set of beam failure detection reference signals from the physical layer reaches a configured threshold before a configured timer expires.

SSB-based Beam Failure Detection is based on the SSB associated to the initial DL BWP and can only be configured for the initial DL BWPs and for DL BWPs containing the SSB associated to the initial DL BWP. For other DL BWPs, Beam Failure Detection can only be performed based on CSI-RS.

After beam failure is detected on PCell, the UE:
triggers beam failure recovery by initiating a Random Access procedure on the PCell;
selects a suitable beam to perform beam failure recovery (if the gNB has provided dedicated Random Access resources for certain beams, those will be prioritized by the UE).
includes an indication of a beam failure on PCell in a BFR MAC CE if the Random Access procedure involves contention-based random access.

Upon completion of the Random Access procedure, beam failure recovery for PCell is considered complete.

After beam failure is detected on an SCell, the UE:
triggers beam failure recovery by initiating a transmission of a BFR MAC CE for this SCell;
selects a suitable beam for this SCell (if available) and indicates it along with the information about the beam failure in the BFR MAC CE.

Upon reception of a PDCCH indicating an uplink grant for a new transmission for the HARQ process used for the transmission of the BFR MAC CE, beam failure recovery for this SCell is considered complete.

After beam failure is detected for a TRP of Serving Cell, the UE:
triggers beam failure recovery by initiating a transmission of a BFR MAC CE for this TRP;
selects a suitable beam for this TRP (if available) and indicates whether the suitable (new) beam is found or not along with the information about the beam failure in the BFR MAC CE for this TRP.

Upon reception of a PDCCH indicating an uplink grant for a new transmission for the HARQ process used for the transmission of the BFR MAC CE for this TRP, beam failure recovery for this TRP is considered complete.

After beam failure is detected for both TRPs of PCell, the UE:
triggers beam failure recovery by initiating a Random Access procedure on the PCell;
selects a suitable beam for each failed TRP (if available) and indicates whether the suitable (new) beam is found or not along with the information about the beam failure in the BFR MAC CE for each failed TRP;
upon completion of the Random Access procedure, beam failure recovery for both TRPs of PCell is considered complete.”

In Rel-15 NR, a TCI (Transmission Configuration Indicator) state is used to configure (by Radio Resource Control (RRC)) a number of beams supported by the cell. Up to 64 states/beams can be configured for Physical Downlink Control Channel (PDCCH)/Control-Resource Set (CORESET) and only one can be activated semi-statically via a Media Access Control (MAC) Control Element (CE). Up to 128 states/beams can be configured for Physical Downlink Shared Channel (PDSCH) and 8 states can be activated semi-statically via a MAC CE, however, the PDCCH can indicate one of the 8 states dynamically for PDSCH transmission.

It has been recognized that an introduction of AI/ML in an NR air interface may have impact on the beam management procedure, as indicated above. With an inference capability on neighbour beams and/or a serving beam, the beam management procedure can be greatly improved in some embodiments, e.g., a UE may switch to a suitable beam even before a beam failure happens.

The present disclosure is concerned with how to optimize a beam failure detection and a recovery procedure based on an input from an AI/ML model. It is assumed that a UE side or a network side or both have inference results from an AI/ML model, e.g., beams, a predicted RSRP of the beams, a predicted RSRP of future time instances of beams etc.

Conditioned or delayed beam level mobility is proposed, based on an input from an AI/ML model for beam management. A beam failure performance may also benefit from the AI/ML model in order to reduce a beam failure duration as well as to reduce a beam failure frequency. Corresponding signaling to support the optimized beam management may be designed accordingly.

In some embodiments, beam failure can be greatly reduced if predictions by an AI/ML model on the beam link quality can be introduced. As in Rel-17, beam level mobility may be introduced to further reduce a “handover” occurrence and an AI/ML model input may further optimize a performance of beam level mobility.

Furthermore, in some embodiments, a network (e.g., a base station and/or a core network) takes actions based on an output of the AI/ML model. For example, an inference from the AI/ML model may be configured to a UE in order to allow the UE to be aware of candidate beams when it needs. However, continuous monitoring on all the candidate beams may drain a battery of the UE quickly. Thus, if a large number of candidate beams are configured to the UE, then the UE may consume power for performing measurements and processing the measurement results, while on the other hand, when there are configured a limited number of candidate beams, there may be a possibility that the UE misses some good candidate beams or encounters more beam failures. Thus, a balance between the mobility performance and power consumption may be considered. Thanks to the introduction of an AI/ML model which can provide a reliable prediction on suitable candidate beams as well as their link quality evolution, and together with additional assistance information, a balance between energy consumption and beam mobility performance (e.g., fewer beam failures occurred) may be achieved in some embodiments.

Consequently, some embodiments pertain to a base station for a mobile telecommunications system, wherein the base station includes circuitry that is configured to: obtain candidate beam information for a user equipment (UE) of the mobile telecommunications system, wherein the candidate beam information is generated by a machine learning model and indicates a candidate beam for beam level mobility of the UE; and configure the candidate beam for communication with the UE according to the candidate beam information.

The mobile telecommunications system may include, for example, New Radio (NR), 5G or any successor thereof, such as 6G. The base station may be a base station according to a specification of the mobile telecommunications system, e.g., a gNodeB (gNB) for NR, and may be configured to provide one or more beams to which one or more UEs may connect.

The base station may be provided on a network side of the mobile telecommunications system and may be connected with a core network of the mobile telecommunications system.

The circuitry may include a programmed microprocessor, an application-specific integrated circuit (ASIC), a field-programmable gate array (FPGA) or the like, that is capable of performing the processing described herein. The circuitry may include a storage unit, which may be based on flash memory, dynamic random-access memory (DRAM), electrically erasable programmable read-only memory (EEPROM) or the like. The storage unit may store instructions that, when executed by the circuitry, cause the circuitry to perform the processing. The circuitry may further include a communication interface, e.g., an antenna, for providing beams and communicating with a UE via a NR air interface. For example, the circuitry may include a general-purpose computer as described with reference to FIG. 8.

The machine learning model may include any artificial intelligence/machine learning (AI/ML) model that is capable of providing a prediction for beam management, such as a predicted position of a UE at a certain time instance and/or a predicted link quality of a beam at a position of the UE. For example, the machine learning model may include an algorithmic model such as a support vector machine (SVM) or a random forest, and/or may include a deep learning algorithm such as a Feed-Forward Network, a Residual Network (ResNet), a Recurrent Neural Network (RNN), a Convolutional Neural Network (CNN), a Generative Adversarial Network (GAN), a Transformer Neural Network and/or any other suitable neural network architecture. Architectures of AI/ML models are generally known and, thus, are not described herein in more detail.

The machine learning model may generate the candidate beam information as an inference result, e.g., based on a position and/or a mobility state of the UE. The machine learning model may be trained based on former measurement results and/or beam failure events.

The machine learning model may be executed (e.g., evaluated) by the circuitry of the base station, by circuitry of the UE and/or by circuitry provided in the core network of the mobile telecommunications system. If the machine learning model is not executed by the circuitry of the base station, the obtaining of the candidate beam information may include receiving the candidate beam information from the UE and/or core network node that has executed the machine learning model.

The candidate beam indicated by the candidate beam information may correspond to a beam that is provided by the base station and/or by another (e.g., neighboring) base station and that is predicted, by the machine learning model, to have a sufficient link quality for a communication between the UE and the base station. For example, the machine learning model may predict that the candidate beam provides a sufficient data rate and/or a sufficient robustness. The link quality of the candidate beam may be better than a link quality of a current serving beam of the UE and/or may be predicted to be sufficient in a case when a link quality of the current serving beam deteriorates (e.g., due to a position change of the UE). The candidate beam information may indicate a plurality of candidate beams, each of which is predicted to have a sufficient link quality.

The configuring of the candidate beam may include instructing the UE to select the candidate beam (or one of the plurality of candidate beams) indicated by the candidate beam information as target beam for beam level mobility. In an embodiment in which the machine learning model is not executed by the UE, the configuring may include transmitting the candidate beam information to the UE. New configurations may be introduced as follows, although the configuring may use a legacy signaling (e.g., a radio resource control (RRC) reconfiguration message). However, beam information, e.g., an identifier of a beam and a corresponding predicated RSRP in future N time instances, may come from the machine learning model. After the base station or network obtains this information, it may need to configure such information to the UE. If the machine learning model is UE-side, the UE may report an inference result of the machine learning model to the network.

In some embodiments, the configuring of the candidate beam includes configuring a simultaneous transmission configuration indicator (TCI) update list of a list of cells of the mobile telecommunications system with which the candidate beam is associated within a cell group configuration using a radio resource control (RRC) reconfiguration message.

The simultaneous TCI update list may include a simultaneousTCI-UPdateList1 and/or a simultaneousTCI-UpdateList2 according to NR. The cell group configuration may include a CellGroupConfig according to NR. The base station may include, for a PDSCH TCI, the cell group configuration in the RRC reconfiguration message and may transmit the RRC reconfiguration message to the UE.

In some embodiments, the configuring of the candidate beam includes configuring a physical downlink shared channel (PDSCH) TCI that is associated with the candidate beam in a TCI information of a serving cell configuration with a RRC reconfiguration message.

The PDSCH TCI may include a pdsch-TCI according to NR. The TCI information may include a TCI-Info according to NR. The serving cell configuration may include a ServingCellConfig according to NR. The base station may include, for a PDSCH TCI, the serving cell configuration in the RRC reconfiguration message and may transmit the RRC reconfiguration message to the UE.

In some embodiments, the circuitry is provided on a network side of the mobile telecommunications system.

The network side may include the base station and the core network of the mobile telecommunications system and may not include the UE. Thus, the circuitry may communicate with the UE via an air interface of the mobile telecommunications network.

In some embodiments, the machine learning model is evaluated by the UE; and the obtaining of the candidate beam information includes receiving the candidate beam information from the UE.

For example, the UE may execute the machine learning model, e.g., based on a measurement result of a link quality measurement performed by the UE. Upon execution, the machine learning model may generate the candidate beam information as an inference result. The UE may then transmit the candidate beam information to the base station.

In some embodiments, the machine learning model is evaluated on a network side of the mobile telecommunications system.

For example, the circuitry of the base station may execute the machine learning model and/or a circuitry of a core network node may execute the machine learning model.

In some embodiments, the circuitry is configured to: receive a measurement report from the UE; obtain the candidate beam information by generating, by the machine learning model, the candidate beam information based on the received measurement report; and transmit to the UE a deactivation signal that instructs the UE to skip sending a measurement report.

For example, the UE may measure a link quality (e.g., a reference signal received power (RSRP)) of one or more beams and may transmit, as the measurement report, the measured link quality to the circuitry.

For a network-sided machine learning model, the UE may report a beam measurement report to the base station or to a core network node in order to assist the inference by the machine learning model. The base station or network node may configure the UE to report the measurement in certain conditions. For example, the UE may transmit the measurement report when a measured RSRP of a beam is above a (e.g., predefined) threshold. Accordingly, the mobile telecommunications system may provide a scheme for allowing the circuitry to disable the measurement report from the UE.

For example, the deactivation signal may deactivate a L1 measurement report (e.g., L1-RSRP) for beam management based on the machine learning model.

In some embodiments, the deactivation signal is based on a physical (L1/PHY) layer signaling. In some embodiments, the deactivation signal is included in Downlink Control Information (DCI).

The measurement report may not always be necessary even if report conditions are fulfilled, as follows.

In some embodiments, the circuitry is configured to transmit the deactivation signal if the circuitry decides that the received measurement report is sufficient for generating a future candidate beam information.

For example, the circuitry of the base station and/or the network may be confident on its future predictions based on the received measurement report, such that a future measurement report may not be needed within a predefined period. Thus, the circuitry may instruct, with the deactivation signal, the UE to skip sending a measurement report that is not needed. Skipping sending a measurement report may save bandwidth on an air interface, which may then be available for other communication. Furthermore, skipping sending a measurement report (and skipping a measurement at all) may save battery power of the UE.

In some embodiments, the circuitry is configured to transmit the deactivation signal if a probability of a beam level switch of the UE is estimated to be low based on a mobility status of the UE.

For example, if the UE is in a static (or nearly static) status (e.g., does not move or moves with a velocity below a predefined threshold), the circuitry may determine that a probability of a beam level switch of the UE is low, and that a measurement report may be skipped.

In some embodiments, the circuitry is further configured to transmit to the UE an activation signal that instructs the UE to resume sending a measurement report.

For example, the circuitry may transmit to the UE an activation/deactivation signal that may instruct the UE to start reporting/stop sending measurement reports. Thus, when the circuitry requires, after sending the deactivation signal to the UE, a new measurement report from the UE, the circuitry may send an activation signal to the UE. Upon receiving the activation signal, the UE may perform a measurement and transmit the corresponding measurement report to the circuitry.

In some embodiments, the deactivation signal instructs the UE to skip sending a measurement report for a predefined number of measurement cycles.

The UE may skip sending a measurement report for the predefined number of measurement cycles upon receiving the measurement report. After skipping the predefined number of measurement cycles, the UE may resume (performing a measurement and) transmitting a measurement report to the circuitry. The circuitry may determine the number of measurement cycles to be skipped based on, e.g., a mobility status of the UE, a confidence interval of an inference result of the machine learning model, an (e.g., empirical) confidence associated with the machine learning model and/or any suitable criterion. The predefined number of measurement cycles may be determined by a specification of the mobile telecommunications system.

For example, the deactivation signal may indicate to skip a measurement report for one period time (such that the UE may resume sending a measurement report for a next measurement cycle), or for a designated number of measurement cycles.

In some embodiments, the deactivation signal instructs the UE to skip sending a measurement report for a predefined time period.

The UE may skip sending a measurement report for the predefined time period upon receiving the measurement report. When the predefined time period has elapsed, the UE may resume (performing a measurement and) transmitting a measurement report to the circuitry. The circuitry may determine the predefined time period for skipping a measurement report based on, e.g., a mobility status of the UE, a confidence interval of an inference result of the machine learning model, an (e.g., empirical) confidence associated with the machine learning model and/or any suitable criterion. The predefined time period may be determined by a specification of the mobile telecommunications system.

In some embodiment, the measurement report indicates a reference signal received power (RSRP) of a physical channel on which the UE receives a beam.

For example, the RSRP may correspond to a linear average over power contributions of resource elements that carry cell-specific reference signals within a considered measurement frequency bandwidth and within a considered downlink radio frame.

In some embodiments, the configuring of the candidate beam includes configuring a switching condition for switching to the candidate beam.

The switching condition may indicate a condition upon which, when the condition is fulfilled, the UE should switch from a current serving beam to the candidate beam indicated by the candidate beam information. For example, the circuitry of the base station or of a core network node may be configured to determine, as the switching condition, a suitable condition for switching to the candidate beam. The configuring of the switching condition may include transmitting, from the circuitry to the UE, an instruction to apply the switching condition. The configuring of the switching condition may further include receiving the instruction by the UE and applying, by the UE, the switching condition according to the instruction, e.g., determining that the switching condition is fulfilled and switching from a current serving beam to the candidate beam (i.e., performing beam level mobility) upon determining that the switching condition is fulfilled.

Thus, the circuitry may anticipate a situation in which switching beams is advantageous, and the UE may be prepared to switch beams accordingly when the situation occurs without requiring further instructions from the circuitry.

For example, if needed, the circuitry may send a Media Access Control (MAC) Control Element (CE)/Downlink Control Information (DCI) to activate/deactivate beams and/or Transmission Configuration Indicators (TCI) that may have been configured via RRC before. When the circuitry may have the candidate beam information from the machine learning model, a corresponding beam switch may not take place at once, e.g., a current serving beam RSRP may be acceptable, or the prediction may refer to a relatively long future and the circuitry may be confident on the prediction by the machine learning model. In such cases, the configuration according to the candidate beam information may allow the UE to be aware how a link quality of the current serving beam evolves. The circuitry may then still send an activation/deactivation command for switching beams, but with some pre-configured conditions to execute.

Such an activation/deactivation scheme may provide one or more of the following advantages.

For example, the UE may receive from the circuitry a command for switching beams when a radio link of the current serving beam is still acceptable. Therefore, a radio link failure probability may be reduced.

For example, the UE may have a measurement result of the current serving beam and of one or more candidate beams. Therefore, the UE may perform a beam switch on its own without further intervene from the base station or from the core network, after receiving the instructions from the circuitry.

For example, measurements by the UE may compensate potential deviations from an inference of the machine learning model, as the UE may have a latest measurement result and may know which beam may be a best beam for the UE. The network may only configure some basic conditions for the UE to follow, but the UE may decide to which beam to switch according to a situation of the switching. So, in some embodiments, although the inference of the machine learning model may be not ideal, this may be compensated by the UE.

There may be different alternatives on which condition(s) may be associated with a respective TCI to be activated/deactivated in the MAC CE, e.g., TCI States Activation/Deactivation for UE-specific PDSCH MAC CE (for intra-cell beam management), Enhanced TCI States Activation/Deactivation for UE-specific PDSCH MAC CE (for inter-cell beam management) or Unified TCI States Activation/Deactivation MAC CE (for inter-cell beam management).

In some embodiments, the switching condition indicates switching to the candidate beam if a beam quality of a serving beam is below a predefined threshold. In some embodiments, the switching condition indicates switching to the candidate beam if a beam quality of the candidate beam exceeds a predefined threshold.

Accordingly, a link quality referred to by the switching condition may be based on a link quality of the serving beam, of a candidate beam or both. For example, the UE may activate the candidate beam when the serving beam link quality is below a (e.g., predefined) threshold, or the candidate beam may be activated when its link quality is above a (e.g., predefined) threshold.

The threshold for each candidate beam and/or its link quality may be different in different future time slots, e.g., for a same beam 1, when it is considered as a candidate beam in time slot N, the corresponding activation threshold may be T₁, and when it is considered as a candidate beam in time slot N+1, the corresponding activation threshold may be T₂, with T₂>T₁. The reason behind the different thresholds may be that the closer the time is, the better a prediction accuracy may be, such that for later times a higher bar for the link quality (e.g., RSRP) may be chosen. Note that this a just an example. The circuitry may provide a predicted beam RSRP value to the UE as well.

In some embodiments, the switching condition indicates a time duration after which switching to the candidate beam based on the candidate beam information is not allowed anymore.

For example, the circuitry may specify after how long an activation/deactivation command for switching beams may not be feasible any longer. For example, the time duration may indicate how long the candidate beam information is considered to be valid, e.g., after the time duration, a prediction accuracy may be significantly reduced.

The circuitry may provide the UE with an indication when the prediction has been made (e.g., a timestamp of the prediction), such that the UE may itself decide whether it is still appropriate to switch to a respective candidate beam based on the prediction.

The circuitry may also provide a series of candidate beams in a time order, e.g., TCI state 1, time N, TCI state 1, time N+1, TCI state 2, time N, TCI state 2, time N+1 etc., and their associated conditions (link quality and/or time condition). In such a case, the UE may have a better view on how the link quality of the respective candidate beams may evolve, and therefore may be able to make a better switch decision.

In some embodiments, the time duration is based on the machine learning model.

For example, the time duration may be defined according to an inference accuracy/capability of the machine learning model (e.g., of an implementation of the machine learning model), and/or the machine learning model may predict how long the generated machine learning model is valid before it becomes unreliable.

In some embodiments, the time duration is based on an averaging time duration for a measuring result filtering performed by the UE.

For example, the averaging time duration may correspond to a L3 filtering time window.

In some embodiments, the configuring of the switching condition includes transmitting the switching condition in a Media Access Control (MAC) Control Element (CE) to the UE.

In some embodiments, the configuring of the switching condition includes transmitting the switching condition in Downlink Control Information (DCI) to the UE.

In some embodiments, the configuring of the candidate beam includes: transmitting the candidate beam information based on Radio Resource Control (RRC) signaling to the UE; and transmitting the switching condition after transmitting the candidate beam information.

In some embodiments, the configuring of the candidate beam includes configuring a plurality of candidate beams for the UE; and the switching condition indicates an associated priority for respective ones of the plurality of candidate beams.

For example, the candidate beam information may indicate the plurality of candidate beams and their associated priorities. The priorities associated with the candidate beams may indicate which candidate beam(s) the UE should prefer over another candidate beam. For example, the UE may prefer switching to a candidate beam with a higher associated priority over switching to a candidate beam with a lower associated priority if a link quality of the candidate beam with the higher associated priority is sufficient.

The circuitry may provide the UE with a beam list that associates each beam of the beam list with a respective priority (e.g., the associated priorities may be indicated as numeric values, or the beams may be ordered in the beam list according to their respective associated priorities), as a special condition. The UE may choose a beam from the beam list as candidate beam, but it may be up to the UE to decide which candidate beam to choose, e.g., based on a latest measurement result.

In some embodiments, the associated priority is based on an inference result of the machine learning model.

For example, the machine learning model may predict a link quality, a duration of a sufficient link quality and/or a utilization (e.g., number of connected UEs) for each candidate beam and may generate the associated priorities of the candidate beams accordingly.

In some embodiments, the associated priority is based on a predicted link quality of the respective candidate beams within a certain time range.

For example, the link quality may correspond to an average link quality within the certain time range. The certain time range may, for example, be predefined and/or may be determined by the machine learning model.

In some embodiments, the associated priority is based on a link quality evolution trend of the respective candidate beams.

For example, beams with an improving predicted link quality may have a higher priority than beams whose link quality is not predicted to improve.

In some embodiments, the associated priority is based on service characteristics requirements of the UE.

For example, a beam with a stable predicted link quality may have a higher priority than a beam whose link quality is predicted to be better but only for a short time before becoming unstable. Thus, a number of beam switches may be reduced.

In some embodiments, the configuring of the candidate beam includes configuring a plurality of candidate beams for the UE in a time order and a switching condition for respective ones of the plurality of candidate beams.

For example, the beam priority may be based on the link quality and/or time range, thus covering the link quality and/or time. However, a difference between beam priority in general and link quality/time range in special may be that the beam priority may be provided by the circuitry allowing the UE to understand how the priorities have been generated. Thus, the beam priority may be not transparent to the UE. On the other hand, with a link quality and/or time information, the UE may be provided with more information and therefore may better be able to make an informed decision. An explicit information provided to the UE may be different via providing a beam priority or a link quality/threshold/time range etc.

Accordingly, some embodiments pertain to a user equipment (UE) for a mobile telecommunications system, wherein the UE includes circuitry that is configured to: obtain candidate beam information for the UE, wherein the candidate beam information is generated by a machine learning model and indicates a candidate beam for beam level mobility of the UE; and configure the candidate beam for communication with a base station of the mobile telecommunications system according to the candidate beam information.

The UE may include any device that is configured to connect to a base station of the mobile telecommunications system via an air interface according to a specification of the mobile telecommunications system. For example, the UE may include a smartphone, tablet computer, notebook, smart watch, smart glasses or the like. The UE may include a vehicle such as a car or a truck as well as a robot (e.g., a production robot and/or a self-driving robot), a drone (e.g., a quadcopter) or the like.

Similar to the circuitry of the base station described above, the circuitry of the UE may include a programmed microprocessor, an ASIC, an FPGA or the like, that is capable of performing the processing described herein. The circuitry may further include a storage unit, which may be based on flash memory, DRAM, EEPROM or the like, and may store instructions that, when executed by the circuitry, cause the circuitry to perform the processing. The circuitry may further include a communication interface, e.g., an antenna, for receiving beams and communicating with a base station via a NR air interface. For example, the circuitry may include a general-purpose computer as described with reference to FIG. 8.

The circuitry of the UE may be configured as a UE-side counterpart of the base station described above. Therefore, the UE (and/or its circuitry) may have any features that correspond to features described above with reference to the base station (and/or its circuitry).

Accordingly, in some embodiments, the configuring of the candidate beam includes configuring a simultaneous transmission configuration indicator update list of a list of cells of the mobile telecommunications system with which the candidate beam is associated within a cell group configuration based on a radio resource control reconfiguration message. In some embodiments, the configuring of the candidate beam includes configuring a PDSCH TCI that is associated with the candidate beam in a TCI information of a serving cell configuration based on a RRC reconfiguration message. In some embodiments, the base station is provided on a network side of the mobile telecommunications system. In some embodiments, the obtaining of the candidate beam information includes evaluating the machine learning model. In some embodiments, the machine learning model is evaluated on a network side of the mobile telecommunications system; and the obtaining of the candidate beam information includes receiving the candidate beam information from the base station. In some embodiments, the circuitry is configured to: transmit a measurement report to the base station for generating the candidate beam information based on the measurement report; receive from the base station a deactivation signal that instructs the UE to skip sending a measurement report; and skip sending a measurement report according to the deactivation signal. In some embodiments, the deactivation signal is based on a PHY signaling. In some embodiments, the deactivation signal is included in DCI. In some embodiments, the circuitry is configured to receive the deactivation signal if the network decides that the transmitted measurement report is sufficient for generating a future candidate beam information. In some embodiments, the circuitry is configured to receive the deactivation signal if a probability of a beam level switch of the UE is estimated to be low based on a mobility status of the UE. In some embodiments, the circuitry is further configured to: receive from the base station an activation signal that instructs the UE to resume sending a measurement report, and resume sending a measurement report according to the activation signal. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam. In some embodiments, the configuring of the candidate beam includes configuring a switching condition for switching to the candidate beam. In some embodiments, the switching condition indicates switching to the candidate beam if a beam quality of a serving beam is below a predefined threshold. In some embodiments, the switching condition indicates switching to the candidate beam if a beam quality of the candidate beam exceeds a predefined threshold. In some embodiments, the switching condition indicates a time duration after which switching to the candidate beam based on the candidate beam information is not allowed anymore. In some embodiments, the time duration is based on the machine learning model. In some embodiments, the time duration is based on an averaging time duration for a measuring result filtering performed by the UE. In some embodiments, the obtaining of the candidate beam information includes receiving the switching condition in a MAC CE from the base station. In some embodiments, the obtaining of the candidate beam information includes receiving the switching condition in DCI from the base station. In some embodiments, the obtaining of the candidate beam information includes: receiving the candidate beam information based on RRC signaling from the base station; and receiving the switching condition after receiving the candidate beam information. In some embodiments, the configuring of the candidate beam includes configuring a plurality of candidate beams for the UE; and the switching condition indicates an associated priority for respective ones of the plurality of candidate beams. In some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE. In some embodiments, the configuring of the candidate beam includes configuring a plurality of candidate beams for the UE in a time order and a switching condition for respective ones of the plurality of candidate beams.

Some embodiments pertain to a circuitry for a mobile telecommunications system, wherein the circuitry is configured to: obtain candidate beam information for a UE of the mobile telecommunications system, wherein the candidate beam information is generated by a machine learning model and indicates a candidate beam for beam level mobility of the UE; and configure the candidate beam for communication with the UE according to the candidate beam information.

The circuitry may be provided in a network node of a core network of the mobile telecommunications system. For example, the circuitry may communicate with a base station of the mobile telecommunications system via the core network. The circuitry may further communicate with the UE of the mobile telecommunications system, as described above, via the base station.

The circuitry may be configured as a network-side counterpart of the UE described above. Thus, apart from being provided separately from the base station, the circuitry may be configured correspondingly like the (circuitry of) the base station of the telecommunications system described above, and the circuitry may have any features that correspond to features described above with reference to the base station (and/or its circuitry). For example, the circuitry may include a general-purpose computer as described with reference to FIG. 8.

Furthermore, the circuitry may include a graphics processing unit (GPU) and/or a tensor processing unit (TPU). Thus, the circuitry may be configured to train and/or execute the machine learning model faster and/or more energy efficient than a central processing unit (CPU) that is not specialized for evaluating the machine learning model (e.g., a deep neural network).

The circuitry provided in the core network may receive requests from one or more base stations of the mobile telecommunications system to train and/or execute machine learning models for one or more UEs connected to the one or more base stations. The circuitry may further receive input information for the machine learning models (e.g., measurement reports from the respective UEs that indicate link qualities of respective beams, mobility states of the respective UEs, or the like) from the base station(s) and input the received input information to the respective machine learning models. The circuitry may train and/or execute the respective machine learning models accordingly and may transmit candidate beam information that is based on inference results output from the respective machine learning models to the respective base station(s).

Providing the circuitry for training and/or executing the machine learning model at a central site and/or for a plurality of base stations may allow a more efficient utilization of hardware for evaluating the machine learning model(s), a powerful electrical power supply that may not be available at every base station, a more efficient and/or more powerful cooling of the hardware and/or easier maintenance than if hardware for evaluating the machine learning model(s) were provided at each base station separately.

In some embodiments, the configuring of the candidate beam includes configuring a simultaneous TCI update list of a list of cells of the mobile telecommunications system with which the candidate beam is associated within a cell group configuration using a radio resource control reconfiguration message. In some embodiments, the configuring of the candidate beam includes configuring a PDSCH TCI that is associated with the candidate beam in a TCI information of a serving cell configuration with a RRC reconfiguration message. In some embodiments, the circuitry is provided on a network side of the mobile telecommunications system. In some embodiments, the machine learning model is evaluated by the UE; and the obtaining of the candidate beam information includes receiving the candidate beam information from the UE. In some embodiments, the machine learning model is evaluated on a network side of the mobile telecommunications system. In some embodiments, the circuitry is configured to: receive a measurement report from the UE; obtain the candidate beam information by generating, by the machine learning model, the candidate beam information based on the received measurement report; and transmit to the UE a deactivation signal that instructs the UE to skip sending a measurement report. In some embodiments, the deactivation signal is based on a PHY signaling. In some embodiments, the deactivation signal is included in DCI. In some embodiments, the circuitry is configured to transmit the deactivation signal if the circuitry decides that the received measurement report is sufficient for generating a future candidate beam information. In some embodiments, the circuitry is configured to transmit the deactivation signal if a probability of a beam level switch of the UE is estimated to be low based on a mobility status of the UE. In some embodiments, the circuitry is further configured to transmit to the UE an activation signal that instructs the UE to resume sending a measurement report. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam. In some embodiments, the configuring of the candidate beam includes configuring a switching condition for switching to the candidate beam. In some embodiments, the switching condition indicates switching to the candidate beam if a beam quality of a serving beam is below a predefined threshold. In some embodiments, the switching condition indicates switching to the candidate beam if a beam quality of the candidate beam exceeds a predefined threshold. In some embodiments, the switching condition indicates a time duration after which switching to the candidate beam based on the candidate beam information is not allowed anymore. In some embodiments, the time duration is based on the machine learning model. In some embodiments, the time duration is based on an averaging time duration for a measuring result filtering performed by the UE. In some embodiments, the configuring of the switching condition includes transmitting the switching condition in a MAC CE to the UE. In some embodiments, the configuring of the switching condition includes transmitting the switching condition in DCI to the UE. In some embodiments, the configuring of the candidate beam includes: transmitting the candidate beam information based on RRC signaling to the UE; and transmitting the switching condition after transmitting the candidate beam information. In some embodiments, the configuring of the candidate beam includes configuring a plurality of candidate beams for the UE; and the switching condition indicates an associated priority for respective ones of the plurality of candidate beams. In some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE. In some embodiments, the configuring of the candidate beam includes configuring a plurality of candidate beams for the UE in a time order and a switching condition for respective ones of the plurality of candidate beams.

Some embodiments pertain to a method for a mobile telecommunications system, wherein the method includes: obtaining candidate beam information for a UE of the mobile telecommunications system, wherein the candidate beam information is generated by a machine learning model and indicates a candidate beam for beam level mobility of the UE; and configuring the candidate beam for communication with the UE according to the candidate beam information.

The method may be performed by (the circuitry of) the base station described above and/or by the circuitry (of a network node in the core network) described above. Accordingly, the method may have features corresponding to any features described above with respect to the base station and/or to the circuitry of the network node.

Some embodiments pertain to a method for a UE of a mobile telecommunications system, wherein the method includes: obtaining candidate beam information for the UE, wherein the candidate beam information is generated by a machine learning model and indicates a candidate beam for beam level mobility of the UE; and configuring the candidate beam for communication with a base station of the mobile telecommunications system according to the candidate beam information.

The method may be performed by (the circuitry of) the UE of the mobile telecommunications system described above. Accordingly, the method may have features corresponding to any features described above with respect to the UE.

Furthermore, some embodiments pertain to a base station for a mobile telecommunications system, wherein the base station includes circuitry that is configured to: receive a measurement report from a UE of the mobile telecommunications system; generate, by a machine learning model, candidate beam information for the UE, wherein the candidate beam information indicates a candidate beam for beam level mobility of the UE and is based on the received measurement report; and transmit to the UE a deactivation signal that instructs the UE to skip sending a measurement report.

Similar to the base station described above, the mobile telecommunications system may include, for example, NR, 5G or any successor thereof, such as 6G, and the base station may be a base station according to a specification of the mobile telecommunications system, e.g., a gNB for NR, and may be configured to provide one or more beams to which one or more UEs may connect.

The base station may be provided on a network side of the mobile telecommunications system and may be connected with a core network of the mobile telecommunications system.

Similar to the circuitry of the base station described above, the circuitry of the base station may include a programmed microprocessor, an ASIC, an FPGA or the like, that is capable of performing the processing described herein. The circuitry may further include a storage unit, which may be based on flash memory, DRAM, EEPROM or the like, and may store instructions that, when executed by the circuitry, cause the circuitry to perform the processing. The circuitry may further include a communication interface, e.g., an antenna, for providing beams and communicating with a UE via a NR air interface. For example, the circuitry may include a general-purpose computer as described with reference to FIG. 8.

The machine learning model and the candidate beam information may correspond to the machine learning model and to the candidate beam information, respectively, described above.

The base station and/or its circuitry may have the following features, which correspond to the respective features described above.

In some embodiments, the deactivation signal is based on a PHY signaling. In some embodiments, the deactivation signal is included in DCI. In some embodiments, the circuitry is configured to transmit the deactivation signal if the circuitry decides that the received measurement report is sufficient for generating a future candidate beam information. In some embodiments, the circuitry is configured to transmit the deactivation signal if a probability of a beam level switch of the UE is estimated to be low based on a mobility status of the UE. In some embodiments, the circuitry is further configured to transmit to the UE an activation signal that instructs the UE to resume sending a measurement report. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam.

Some embodiments pertain to a UE for a mobile telecommunications system, wherein the UE includes circuitry that is configured to: transmit a measurement report to a base station of the mobile telecommunications system for generating, by a machine learning model evaluated on a network side of the mobile telecommunications system, candidate beam information for the UE, wherein the candidate beam information indicates a candidate beam for beam level mobility of the UE and is based on the received measurement report; receive from the base station a deactivation signal that instructs the UE to skip sending a measurement report; and skip sending a measurement report according to the deactivation signal.

Like the UE described above, the UE may include any device that is configured to connect to a base station of the mobile telecommunications system via an air interface according to a specification of the mobile telecommunications system, including the examples of a UE described above.

Similar to the circuitry of the UE described above, the circuitry of the UE may include a programmed microprocessor, an ASIC, an FPGA or the like, a storage unit and a communication interface, which may be configured as for the UE described above. For example, the circuitry may include a general-purpose computer as described with reference to FIG. 8.

The circuitry of the UE may be configured as a UE-side counterpart of the base station described above. Therefore, the UE (and/or its circuitry) may have any features that correspond to features described above with reference to the base station (and/or its circuitry).

In some embodiments, the deactivation signal is based on a PHY signaling. In some embodiments, the deactivation signal is included in DCI. In some embodiments, the circuitry is configured to receive the deactivation signal if the network decides that the received measurement report is sufficient for generating a future candidate beam information. In some embodiments, the circuitry is configured to receive the deactivation signal if a probability of a beam level switch of the UE is estimated to be low based on a mobility status of the UE. In some embodiments, the circuitry is further configured to: receive from the base station an activation signal that instructs the UE to resume sending a measurement report; and resume sending a measurement report according to the activation signal. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam.

Some embodiments pertain to a circuitry for a mobile telecommunications system, wherein the circuitry is configured to: receive a measurement report from a UE of the mobile telecommunications system; generate, by a machine learning model, candidate beam information for the UE, wherein the candidate beam information indicates a candidate beam for beam level mobility of the UE and is based on the received measurement report; and transmit to the UE a deactivation signal that instructs the UE to skip sending a measurement report.

The circuitry may be provided in a network node of a core network of the mobile telecommunications system. For example, the circuitry may communicate with a base station of the mobile telecommunications system via the core network. The circuitry may further communicate with the UE of the mobile telecommunications system, as described above, via the base station.

Like the circuitry of a network node described above, the circuitry may be configured as a network-side counterpart of the UE described above and may, apart from being provided separately from the base station, be configured correspondingly like the (circuitry of) the base station of the telecommunications system described above. Accordingly, the circuitry may have any features that correspond to features described above with reference to the base station (and/or its circuitry). For example, the circuitry may include a general-purpose computer as described with reference to FIG. 8.

Like the circuitry of a network node described above, the circuitry may include a GPU and/or a TPU for faster and/or more energy efficient training and/or execution of the machine learning model. As described above, the circuitry may train and/or execute the machine learning model for a plurality of base stations, which may have the advantages described above.

In some embodiments, the deactivation signal is based on a PHY signaling. In some embodiments, the deactivation signal is included in DCI. In some embodiments, the circuitry is configured to transmit the deactivation signal if the circuitry decides that the received measurement report is sufficient for generating a future candidate beam information. In some embodiments, the circuitry is configured to transmit the deactivation signal if a probability of a beam level switch of the UE is estimated to be low based on a mobility status of the UE. In some embodiments, the circuitry is further configured to transmit to the UE an activation signal that instructs the UE to resume sending a measurement report. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam.

Some embodiments pertain to a method for a mobile telecommunications system, wherein the method includes: receiving a measurement report from a UE of the mobile telecommunications system, generating, by a machine learning model, candidate beam information for the UE, wherein the candidate beam information indicates a candidate beam for beam level mobility of the UE and is based on the received measurement report; and transmitting to the UE a deactivation signal that instructs the UE to skip sending a measurement report.

The method may be performed by (the circuitry of) the base station described above and/or by the circuitry (of a network node in the core network) described above. Accordingly, the method may have features corresponding to any features described above with respect to the base station and/or to the circuitry of the network node.

In some embodiments, the method includes transmitting the deactivation signal if it is decided that the received measurement report is sufficient for generating a future candidate beam information. In some embodiments, the method includes transmitting the deactivation signal if a probability of a beam level switch of the UE is estimated to be low based on a mobility status of the UE. In some embodiments, the method further includes transmitting to the UE an activation signal that instructs the UE to resume sending a measurement report. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam.

Some embodiments pertain to a method for a UE of a mobile telecommunications system, wherein the method includes: transmitting a measurement report to a base station of the mobile telecommunications system for generating, by a machine learning model evaluated on a network side of the mobile telecommunications system, candidate beam information for the UE, wherein the candidate beam information indicates a candidate beam for beam level mobility of the UE and is based on the received measurement report; receiving from the base station a deactivation signal that instructs the UE to skip sending a measurement report; and skipping sending a measurement report according to the deactivation signal.

The method may be performed by (the circuitry of) the UE of the mobile telecommunications system described above. Accordingly, the method may have features corresponding to any features described above with respect to the UE.

In some embodiments, the method includes receiving the deactivation signal if the network decides that the received measurement report is sufficient for generating a future candidate beam information. In some embodiments, the method includes receiving the deactivation signal if a probability of a beam level switch of the UE is estimated to be low based on a mobility status of the UE. In some embodiments, the method further includes: receiving from the base station an activation signal that instructs the UE to resume sending a measurement report; and resuming sending a measurement report according to the activation signal. In some embodiments, the deactivation signal instructs the UE to skip sending a measurement report for a predefined number of measurement cycles. In some embodiments, the deactivation signal instructs the UE to skip sending a measurement report for a predefined time period. In some embodiments, the measurement report indicates a RSRP of a physical channel on which the UE receives a beam.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, FIG. 1 illustrates a mobile telecommunications system 1 according to an embodiment. The mobile telecommunications system 1 includes a gNB 2 (which is an example of a base station), a user equipment (UE) 3 and a core network 4.

The UE 3 connects to the gNB 2 via a beam 5 provided by the gNB 2. The gNB 2 is connected to the core network 4. The core network 4 includes network nodes (not shown) that control the gNB 2. The core network 4 further includes a gateway to the internet, such that the gNB 2 can provide to the UE 3 access to the internet via its connection to the core network 4.

The gNB 2 also provides beams 6 and 7. The beams 5, 6 and 7 cover different but overlapping regions. The UE 3 is initially located in a region covered by the beam 5 and is connected to the gNB 2 via the beam 5.

Then, the UE 3 moves towards the beam 6, as indicated by an arrow 8. When the UE 3 has reached an edge of the beam 5 and is covered by the beam 6, a link quality of the beam 6 becomes better than a link quality of the beam 5. The UE 3 can therefore perform beam level mobility by switching from the beam 5 to the beam 6 for a better connection to the gNB 2. Candidate beam information generated by a machine learning (ML) model indicates to the UE 3 that it should switch to the beam 6.

However, if the UE 3 does not perform beam level mobility, thus keeping the beam 5 as a serving beam, and moves further towards the beam 7, as indicated by an arrow 9, the UE 3 leaves the beam 5 and suffers from a beam failure. For recovering from the beam failure, the UE 3 can resume a communication with the gNB 2 via the beam 6 or via the beam 7. Candidate beam information generated by a machine learning (ML) model indicates to the UE 3 which one of the beam 6 and the beam 7 to use for beam failure recovery.

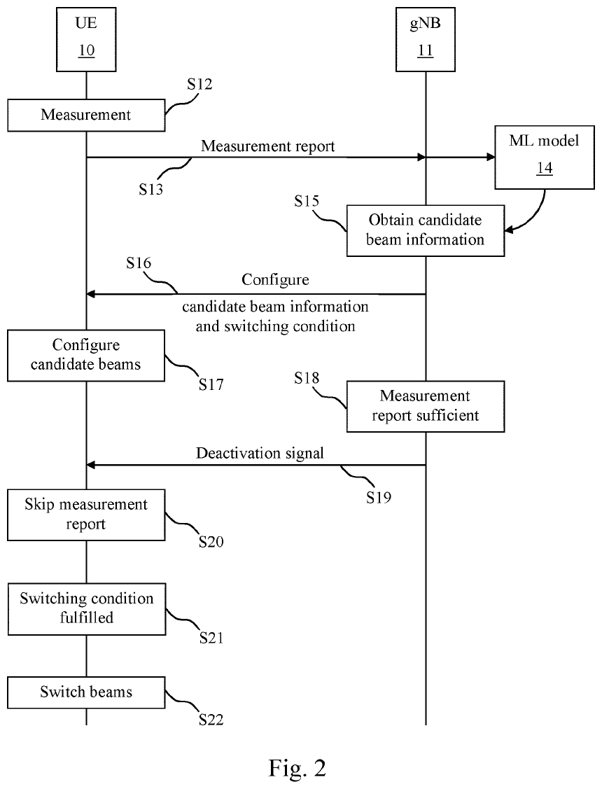

FIG. 2 illustrates a method for beam level mobility with a network-side machine learning model 14 according to an embodiment. The method is performed by a UE 10 and a gNB 11 of a mobile telecommunications system, for example by the UE 3 and the gNB 2 of the mobile telecommunications system 1 of FIG. 1.

At S12, the UE 10 performs a measurement by measuring a RSRP of beams provided by the gNB 11 and transmits, at S13, to the gNB 11 a measurement report that indicates a result of the measurement.

A circuitry of the gNB 11 executes a ML model 14, and the gNB 11 provides to the ML model 14 the measurement report as well as an indication of a mobility state of the UE 10. The ML model 14 is provided at a network side of the mobile telecommunications system and generates, based on the measurement report, candidate beam information as an inference result. The candidate beam information indicates beams provided by the gNB 2 as candidate beams for beam level mobility of the UE 10 based on the measurement report and on the mobility state of the UE 10.

At S15, the gNB 11 obtains the candidate beam information from the ML model 14, determines a switching condition for switching to the candidate beams indicated by the candidate beam information and, at S16, configures the candidate beam information and the switching condition for the UE 10. The configuring at S16 includes transmitting the candidate beam information and an indication of the switching conditions to the UE 10. The gNB 11 transmits the candidate beam information via RRC and the indication of the switching condition via physical layer (PHY) signaling included in downlink control information (DCI). An example of the switching condition is described later with reference to FIG. 4.

The UE 10 receives the candidate beam information and the indication of the switching conditions. At S17, the UE 10 configures the candidate beams indicated by the candidate beam information. The configuring at S17 includes applying the candidate beam information and keeping an indication of the candidate beams for switching to a candidate beam if its associated switching condition is fulfilled.

At S18, the gNB 11 determines that the measurement report that has been transmitted at S13 is sufficient for a subsequent execution of the ML model 14 such that the gNB 11 needs no measurement report from the UE 10 for a subsequent measurement cycle. Therefore, at S19, the gNB 11 transmits, via physical layer (PHY) signaling, to the UE 10 a deactivation signal that instructs the UE 10 to skip sending a measurement report for the subsequent measurement cycle. The deactivation signal is included in downlink control information (DCI).

The UE 10 receives the deactivation signal and, at S20, skips transmitting the subsequent report accordingly.

At S21, the UE 10 determines that a switching condition associated with a candidate beam configured at S17 is fulfilled. Therefore, at S22, the UE 10 switches from a current serving beam to the candidate beam whose associated switching condition is fulfilled.

Note that, although the ML model 14 is executed by a circuitry of the gNB 11 in FIG. 2, the ML model 14 is executed in some embodiments by a network node included in a core network (e.g., in the core network 4 of FIG. 1), and the gNB 11 obtains the candidate beam information from the ML model 14 via the core network 4.

Note also that, in some embodiments, the gNB 11 does not determine at S15 and configure at S16 a switching condition but only the candidate beam information. The UE 10 may then decide on its own when and to which candidate beam to perform beam level mobility.

Note further that, in some embodiments, the method sections S18, S19 and S20 are not performed. Thus, the gNB 11 may not send the deactivation signal, and the UE 10 may continue transmitting measurement reports.

Note further that, in some embodiments, the UE 10 additionally measures at S12 a link quality of one or more beams provided by another base station than the gNB 11 and reports the corresponding measurement result to the gNB 11 at S13. The ML model 14 may include one or more of the beam(s) provided by the other base station as candidate beam(s) in the candidate beam information.

In addition, note that, in some embodiments, at S16, the gNB 11 transmits the switching condition via Media Access Control (MAC) signaling, e.g., included in a MAC Control Element (CE), instead of PHY signaling, or transmits the switching condition together with the candidate beam information via RRC.

Note that any one of S18, S19 and S20 may be performed before any one of S15, S16 and S17 and/or after any one of S21 and S22 in some cases.

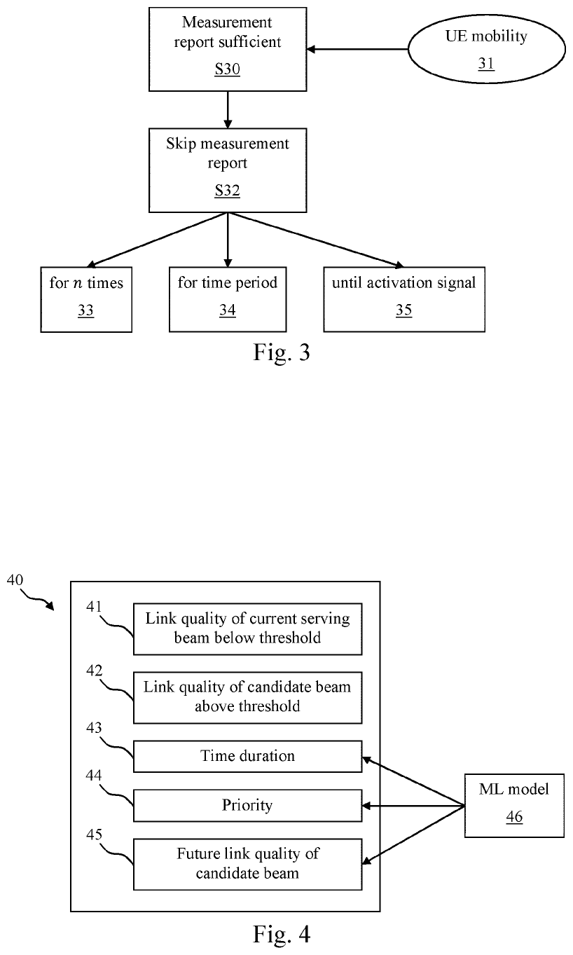

FIG. 3 illustrates a method for skipping a measurement report according to an embodiment. The method is performed, for example, by a circuitry of the gNB 2 of FIG. 1, of the gNB 11 of FIG. 2 or of a network node in the core network 4 of FIG. 1.

At S30, the circuitry determines that a measurement report that the circuitry has received from a UE (e.g., the measurement report transmitted by the UE 10 at S13 of FIG. 2) is sufficient for a subsequent generation of candidate beam information by a ML model (e.g., by the ML model 14 of FIG. 2). The determination of S30 is based on a mobility state 31 of the UE. In the case of FIG. 3, the mobility state 31 indicates that the UE is not moving. Therefore, the circuitry determines that a probability of a significant change in a link quality of a current serving beam of the UE or of a determined candidate beam is below a predefined threshold and that, accordingly, the previous measurement report is sufficient as input to the ML model for a subsequent generation of candidate beam information.

Therefore, at S32, the circuitry decides that the UE should skip transmitting the subsequent measurement report to the circuitry. The circuitry prepares a corresponding deactivation signal for transmission to the UE.

The circuitry further inserts in the deactivation signal an indication of an activation condition at which the UE should resume transmitting a measurement report to the circuitry. The circuitry selects the activation condition case by case out of three possible activation conditions.

A first possible activation condition 33 is that the UE should skip transmitting a measurement report for a predefined number n of times (i.e., of measurement cycles) and that the UE should resume transmitting a measurement report after n measurement reports have been skipped. The UE can choose any suitable number for n, e.g., 1, 2, 3 or 10 (without limiting the disclosure to these numbers), as appropriate in each respective case.

A second possible activation condition 34 is that the UE should skip transmitting a measurement report for a predefined time period, e.g., for a second, for ten seconds or for a minute (without limiting the disclosure to these numbers), as appropriate in each respective case.

A third possible activation condition 35 is that the UE should skip transmitting a measurement report until the circuitry sends an activation signal to the UE. The activation signal instructs the UE to resume transmitting a measurement report. Thus, the circuitry can postpone a decision to instruct the UE to resume transmitting a measurement report to a point in time after transmitting the deactivation signal.

The circuitry then sends the deactivation signal with the indication of the activation condition to the UE, e.g., at S19 of FIG. 2.

Note that, in some embodiments, the circuitry inserts more than one of the first to third possible activation conditions 33 to 35 in the deactivation signal, thus instructing the UE to resume transmitting a measurement report when any one of the inserted activation conditions is fulfilled, or when all inserted activation conditions are fulfilled. Note also that, in some embodiments, the circuitry does not select which activation condition to insert in the deactivation signal, but the activation condition may be predefined, e.g., by a specification of the mobile telecommunications system.

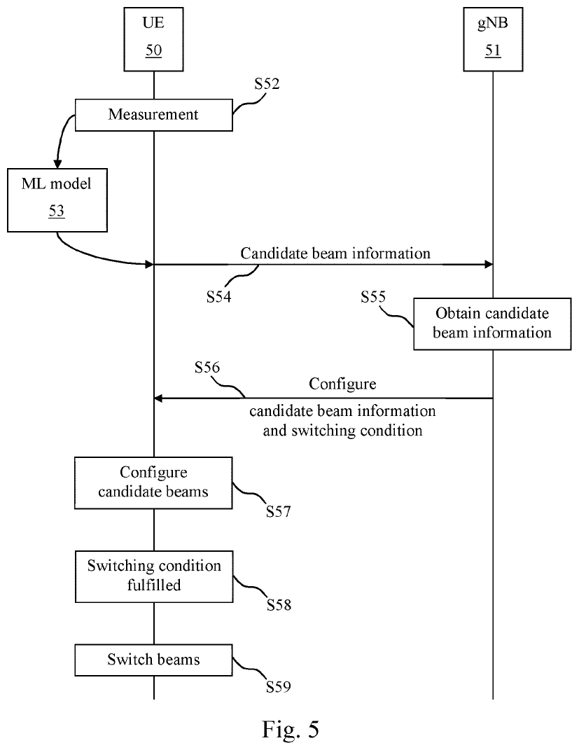

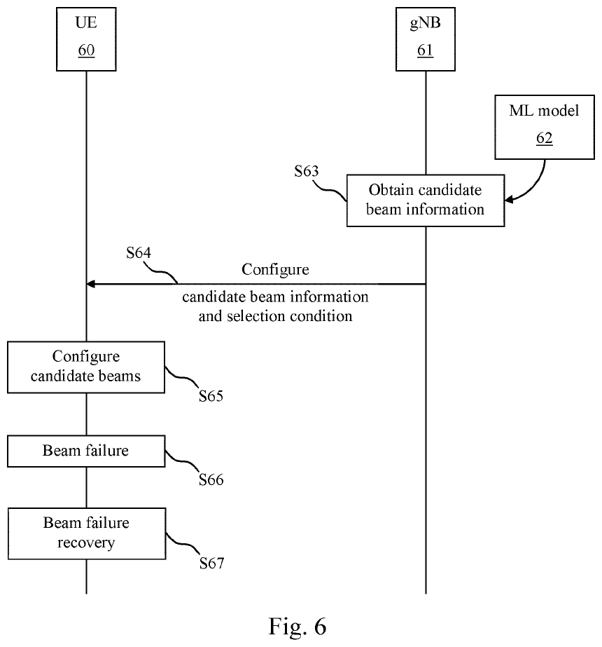

FIG. 4 illustrates a condition 40 associated with a candidate beam according to an embodiment. The condition 40 is an example of the switching condition configured at S16 of FIG. 2 or at S56 of FIG. 5. The condition 40 is also an example of the selection condition configured at S64 of FIG. 6.

The condition 40 indicates a first criterion 41 that is met if a link quality of a current serving beam is below a predefined threshold.

The condition 40 indicates a second criterion 42 that is met if a link quality of a candidate beam is above a predefined threshold.

The condition 40 indicates a third criterion 43 that is met as long as a time duration has not expired. When the time duration expires, candidate beam information that corresponds to the condition 40 becomes invalid, and a UE (e.g., the UE 3 of FIG. 1, the UE 10 of FIG. 2, the UE 50 of FIG. 5 or the UE 60 of FIG. 6) should not consider a beam associated with the condition 40 as a candidate beam based on the corresponding candidate beam information anymore, and the UE should not switch to the respective beam based on the corresponding candidate beam information anymore. The time duration determined is based on an averaging time duration for a measuring result filtering performed by the UE.

The condition 40 indicates a fourth criterion 44 that indicates a priority for respective candidate beams indicated by corresponding candidate beam information. The fourth criterion 44 is met for a candidate beam if the candidate beam is the candidate beam associated with a highest priority, among all candidate beams that are associated with a respective priority by the fourth criterion 44, whose link quality fulfills a respective threshold indicated by the fourth criterion 44.

The condition 40 indicates a fifth criterion 45 that is fulfilled if a link quality of a corresponding candidate beam at a predefined future point in time corresponds to a predicted link quality of the candidate beam that has previously been predicted for the predefined future point in time.

The third to fifth criteria 43 to 45 are based on an inference result of a ML model 46, e.g., of the ML model 14 of FIGS. 2, 53 of FIG. 5 or 62 of FIG. 6. The time duration of the third criterion 43 is based on a time interval in which a confidence of the inference result is sufficient. The priority of the fourth criterion 44 is based on aspects including a predicted link quality of the respective candidate beams within a certain time range, on a link quality evolution trend of the respective candidate beams and on service characteristics requirements of the corresponding UE. The ML model 46 determines weights for the respective aspects such that the priority corresponds to a weighted combination of the aspects.

For beam level mobility and for beam failure recovery, the UE selects from the candidate beam information a candidate beam for which the condition 40 is fulfilled.

Note that in some embodiments, the condition 40 includes only one or some of the criteria 41 to 45 and/or includes an additional criterion. For example, the ML model 46, a base station and/or a core network node may determine which of the criteria 41 to 45 to include in the condition 40. In cases where the condition 40 includes more than one criterion, the condition 40 may be fulfilled if any one of the included criteria is fulfilled, or the condition 40 may be fulfilled if all included criteria are fulfilled. Any reference of the condition 40 (or its included criteria) to a (link) quality of a beam may correspond to a RSRP of the beam and/or to a quantity that is based on the RSRP of the beam.

FIG. 5 illustrates a method for beam level mobility with a UE-side ML model according to an embodiment. The method is performed by a UE 50 and a gNB 51 of a mobile telecommunications system, e.g., by the UE 3 and the gNB 2 of the mobile telecommunications system 1.

At S52, the UE 50 performs a measurement of a link quality of beams provided by the gNB 51, similar to the measurement at S12 of FIG. 2, and provides a result of the measurement as input to a ML model 53. The ML model 53 is executed by a circuitry of the UE 50 and, thus, is a UE-side ML model. Based on the measurement result, the ML model 53 generates candidate beam information that indicates candidate beams for beam level mobility of the UE 50.

At S54, the UE 50 transmits the candidate beam information to the gNB 51. At S55, the gNB 51 obtains the candidate beam information by receiving the candidate beam information from the UE 50.

The gNB 51 modifies the received candidate beam information and determines a switching condition for switching to the candidate beams indicated by the (modified) candidate beam information. The modifying includes deleting a beam from the candidate beam information if the UE 50 should not connect to the beam, e.g., if the beam is already used to capacity by other UEs in the mobile telecommunications system or if the beam is reserved for other purposes. An example of the switching condition is the condition 40 of FIG. 4.

At S56, the gNB 51 configures the (modified) candidate beam information and the determined switching condition for the UE 50. This includes transmitting the candidate beam information and the switching condition to the UE 50. The gNB 51 transmits the candidate beam information via RRC and transmits the switching condition via PHY signalling included in DCI. The configuring at S56 corresponds to the configuring at S16 of FIG. 2.

At S57, the UE 50 configures candidate beams according to the candidate beam information, similar to the configuring at S17 of FIG. 2.

At S58, the UE 50 determines that the switching condition received from the gNB 51 at S56 is fulfilled and switches from a current serving beam to a candidate beam configured at S56 and S57 according to the switching condition. The processing at S58 and S59 is similar to the processing at S21 and S22 of FIG. 2, respectively.

Note that, in some embodiments, the UE 50 additionally measures at S52 a link quality of one or more beams provided by another base station than the gNB 51, and the ML model 53 includes one or more of the beam(s) provided by the other base station as candidate beam(s) in the candidate beam information.

Note also that, in some embodiments, the gNB 51 does not modify the candidate beam information but configures the candidate beam information as received, at S54, from the UE 50. Further, in some embodiments, the gNB 51 transmits the candidate beam information received at S54 to a core network node, the core network node modifies the candidate beam information and/or determines the switching condition, and the gNB 51 receives the modified candidate beam information and/or the switching condition from the core network node. Further, in some embodiments, the ML model 53 determines the switching condition or at least a criterion of the switching condition, and the UE 50 transmits the switching condition (or the criterion) to the gNB 51 for approval.

Note further that, in some embodiments, at S56, the gNB 51 transmits the switching condition via MAC signaling, e.g., included in a MAC CE, instead of PHY signaling, or transmits the switching condition together with the candidate beam information via RRC.

Furthermore, some embodiments pertain to a base station for a mobile telecommunications system, wherein the base station includes circuitry that is configured to: obtain, from a machine learning model, candidate beam information for a UE of the mobile telecommunications system, wherein the candidate beam information indicates a plurality of candidate beams for beam failure recovery of the UE; and configure the plurality of candidate beams for the UE and a selection condition for selecting a candidate beam of the plurality of candidate beams for beam failure recovery.

Similar to the base stations described above, the mobile telecommunications system may include, for example, NR, 5G or any successor thereof, such as 6G, and the base station may be a base station according to a specification of the mobile telecommunications system, e.g., a gNB for NR, and may be configured to provide one or more beams to which one or more UEs may connect.

The base station may be provided on a network side of the mobile telecommunications system and may be connected with a core network of the mobile telecommunications system.

Similar to the circuitry of the base stations described above, the circuitry of the base station may include a programmed microprocessor, an ASIC, an FPGA or the like, that is capable of performing the processing described herein. The circuitry may further include a storage unit, which may be based on flash memory, DRAM, EEPROM or the like, and may store instructions that, when executed by the circuitry, cause the circuitry to perform the processing. The circuitry may further include a communication interface, e.g., an antenna, for providing beams and communicating with a UE via a NR air interface. For example, the circuitry may include a general-purpose computer as described with reference to FIG. 8.

The candidate beam information may indicate candidate beams based on which the UE may try to resume a communication with the base station in a case where a communication via a previously serving beam has failed, i.e., for recovering from the beam failure. Accordingly, the candidate beams indicated by the candidate beam information may be beams for which the machine learning model predicts a sufficient link quality in a case where a current serving beam fails. Thus, the UE may be prepared for a beam failure recovery, and the candidate beam information may allow a faster beam failure recovery because the UE may already be instructed to try a beam failure recovery on the candidate beams. The candidate beams indicated by the candidate beam information may include one or more beams provided by the base station and/or one or more beams provided by another (e.g., neighboring) base station.

The beam failure recovery may be in place in a case that a wireless communication is interrupted abruptly, e.g., if a wireless signal is physically blocked. Thanks to the machine learning model, the circuitry may have candidate beams for recovery from the beam failure. The candidate beams may improve the beam failure recovery procedure, e.g., by reducing a recovery delay and/or reducing a probability of beam failure declaration after recent recovery.

When the circuitry obtains the candidate beam information, it may decide which candidate beams may be suitable for beam recovery and may then configure the UE accordingly.

Apart from that, the machine learning model, the candidate beam information and the configuring of the plurality of candidate beams for beam failure recovery may correspond to the machine learning model, to the candidate beam information and to the configuring of a plurality of candidate beams, respectively, as described above with respect to beam level mobility.

Aspects and effects of the selection condition may correspond to respective aspects and effects of the switching condition described above.

In some embodiments, the selection condition indicates different respective beam quality thresholds for at least two candidate beams of the plurality of candidate beams according to an inference result of the machine learning model.

For example, the UE may select a candidate beam of the plurality of candidate beams that is associated with a lowest satisfied beam quality threshold among the beam quality thresholds associated with respective ones of the plurality of candidate beams.

For example, in Rel-17 of 5G, there may be one parameter rsrp-ThresholdSSB in, e.g., BeamFailureRecoveryConfig, which may mean rsrp-ThresholdSSB. The parameter rsrp-ThresholdSSB may define a L1-RSRP threshold for determining whether a candidate beam may be used by the UE to attempt contention free random access to recover from beam failure. The L1-RSRP threshold defined by rsrp-ThresholdSSB may be applicable to all candidate beams.

According to the present technology, in which the candidate beams are determined based on a machine learning model, the circuitry may obtain the candidate beams as well as their respective predicted RSRP values. Therefore, according to the present technology, the circuitry may set different RSRP thresholds in order to bias a selection of a candidate beam for recovery. For example, a wide beam may have a lower threshold than a narrow beam in some cases, such that the UE may more likely select the wide beam, which covers a larger area, than the narrow beam, which covers a smaller area. For example, some beams, e.g., a pencil beam, may have a sharp RSRP reduction beyond a certain range, so it may have a higher bar (e.g., a higher beam quality threshold) than other candidate beams.

In some embodiments, the beam quality thresholds relate to a RSRP of the respective candidate beams.

In some embodiments, the circuitry is configured to transmit the candidate beam information to the UE.

Thus, the UE may keep an indication of the candidate beams indicated by the candidate beam information and their respective selection conditions, and if a beam failure occurs, the UE may perform a beam failure recovery on at least one of the candidate beams indicated by the candidate beam information according to the selection conditions.

In some embodiments, the selection condition indicates time information for a candidate beam of the plurality of candidate beams according to an inference result of the machine learning model.

For example, the time information may indicate a time duration, and the UE may be configured to not use a candidate beam based on the candidate beam information and/or the selection condition for beam failure recovery after the time duration has expired.

As described above with respect to beam level mobility, the time information may, e.g., indicate a time duration during which the candidate beam information and the selection condition are considered valid. After the time duration has expired, a prediction accuracy may be significantly reduced, and the UE may be configured to not use a candidate beam based on the candidate beam information and/or the selection condition for beam failure recovery after the time duration has expired.

In some embodiments, the selection condition indicates a predicted link quality in a future time for a candidate beam of the plurality of candidate beams according to an inference result of the machine learning model.

For example, the UE may determine based on the predicted link quality whether the respective candidate beam may be still feasible at a future time when a beam failure happens.

In some embodiments, the selection condition indicates an associated priority for respective ones of the plurality of candidate beams.

For example, the circuitry may configure the candidate beam list with associated priorities as described above with respect to beam level mobility.

In particular, in some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE.

Some embodiments pertain to a UE for a mobile telecommunications system, wherein the UE includes circuitry that is configured to: obtain, from a machine learning model, candidate beam information for the UE, wherein the candidate beam information indicates a plurality of candidate beams for beam failure recovery of the UE; and configure the plurality of candidate beams for communication with a base station of the mobile telecommunication system and a selection condition for selecting a candidate beam of the plurality of candidate beams for beam failure recovery.

Like the UE described above, the UE may include any device that is configured to connect to a base station of the mobile telecommunications system via an air interface according to a specification of the mobile telecommunications system, including the examples of a UE described above.

Similar to the circuitry of the UE described above, the circuitry of the UE may include a programmed microprocessor, an ASIC, an FPGA or the like, a storage unit and a communication interface, which may be configured as for the UE described above. For example, the circuitry may include a general-purpose computer as described with reference to FIG. 8.

The circuitry of the UE may be configured as a UE-side counterpart of the base station described above. Therefore, the UE (and/or its circuitry) may have any features that correspond to features described above with reference to the base station (and/or its circuitry).

In some embodiments, the selection condition indicates different respective beam quality thresholds for at least two candidate beams of the plurality of candidate beams according to an inference result of the machine learning model. In some embodiments, the beam quality thresholds relate to a RSRP of the respective candidate beams. In some embodiments, the obtaining of the candidate beam information includes receiving the candidate beam information from the base station. In some embodiments, the selection condition indicates time information for a candidate beam of the plurality of candidate beams according to an inference result of the machine learning model. In some embodiments, the selection condition indicates a predicted link quality in a future time for a candidate beam of the plurality of candidate beams according to an inference result of the machine learning model. In some embodiments, the selection condition indicates an associated priority for respective ones of the plurality of candidate beams. In some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE.

Some embodiments pertain to a circuitry for a mobile telecommunications system, wherein the circuitry is configured to: obtain, from a machine learning model, candidate beam information for a UE of the mobile telecommunications system, wherein the candidate beam information indicates a plurality of candidate beams for beam failure recovery of the UE; and configure the plurality of candidate beams for the UE and a selection condition for selecting a candidate beam of the plurality of candidate beams for beam failure recovery.

The circuitry may be provided in a network node of a core network of the mobile telecommunications system. For example, the circuitry may communicate with a base station of the mobile telecommunications system via the core network. The circuitry may further communicate with the UE of the mobile telecommunications system, as described above, via the base station.

Like the circuitry of a network node described above, the circuitry may be configured as a network-side counterpart of the UE described above and may, apart from being provided separately from the base station, be configured correspondingly like the (circuitry of) the base station of the telecommunications system described above. Accordingly, the circuitry may have any features that correspond to features described above with reference to the base station (and/or its circuitry). For example, the circuitry may include a general-purpose computer as described with reference to FIG. 8.

Like the circuitry of a network node described above, the circuitry may include a GPU and/or a TPU for faster and/or more energy efficient training and/or execution of the machine learning model. As described above, the circuitry may train and/or execute the machine learning model for a plurality of base stations, which may have the advantages described above.

In some embodiments, the selection condition indicates different respective beam quality thresholds for at least two candidate beams of the plurality of candidate beams according to an inference result of the machine learning model. In some embodiments, the beam quality thresholds relate to a RSRP of the respective candidate beams. In some embodiments, the circuitry is configured to transmit the candidate beam information to the UE. In some embodiments, the selection condition indicates time information for a candidate beam of the plurality of candidate beams according to an inference result of the machine learning model. In some embodiments, the selection condition indicates a predicted link quality in a future time for a candidate beam of the plurality of candidate beams according to an inference result of the machine learning model. In some embodiments, the selection condition indicates an associated priority for respective ones of the plurality of candidate beams. In some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE.

Some embodiments pertain to a method for a mobile telecommunications system, wherein the method includes: obtaining, from a machine learning model, candidate beam information for a UE of the mobile telecommunications system, wherein the candidate beam information indicates a plurality of candidate beams for beam failure recovery of the UE; and configuring the plurality of candidate beams for the UE and a selection condition for selecting a candidate beam of the plurality of candidate beams for beam failure recovery.

The method may be performed by (the circuitry of) the base station described above and/or by the circuitry (of a network node in the core network) described above. Accordingly, the method may have features corresponding to any features described above with respect to the base station and/or to the circuitry of the network node.

In some embodiments, the selection condition indicates different respective beam quality thresholds for at least two candidate beams of the plurality of candidate beams according to an inference result of the machine learning model. In some embodiments, the beam quality thresholds relate to a RSRP of the respective candidate beams. In some embodiments, the method comprises transmitting the candidate beam information to the UE. In some embodiments, the selection condition indicates time information for a candidate beam of the plurality of candidate beams according to an inference result of the machine learning model. In some embodiments, the selection condition indicates a predicted link quality in a future time for a candidate beam of the plurality of candidate beams according to an inference result of the machine learning model. In some embodiments, the selection condition indicates an associated priority for respective ones of the plurality of candidate beams. In some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE.

Some embodiments pertain to a method for a UE of a mobile telecommunications system, wherein the method includes: obtaining, from a machine learning model, candidate beam information for the UE, wherein the candidate beam information indicates a plurality of candidate beams for beam failure recovery of the UE; and configuring the plurality of candidate beams for communication with a base station of the mobile telecommunication system and a selection condition for selecting a candidate beam of the plurality of candidate beams for beam failure recovery.

The method may be performed by (the circuitry of) the UE of the mobile telecommunications system described above. Accordingly, the method may have features corresponding to any features described above with respect to the UE.

In some embodiments, the selection condition indicates different respective beam quality thresholds for at least two candidate beams of the plurality of candidate beams according to an inference result of the machine learning model. In some embodiments, the beam quality thresholds relate to a RSRP of the respective candidate beams. In some embodiments, the obtaining of the candidate beam information includes receiving the candidate beam information from the base station. In some embodiments, the selection condition indicates time information for a candidate beam of the plurality of candidate beams according to an inference result of the machine learning model. In some embodiments, the selection condition indicates a predicted link quality in a future time for a candidate beam of the plurality of candidate beams according to an inference result of the machine learning model. In some embodiments, the selection condition indicates an associated priority for respective ones of the plurality of candidate beams. In some embodiments, the associated priority is based on an inference result of the machine learning model. In some embodiments, the associated priority is based on a predicted link quality of the respective candidate beams within a certain time range. In some embodiments, the associated priority is based on a link quality evolution trend of the respective candidate beams. In some embodiments, the associated priority is based on service characteristics requirements of the UE.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

FIG. 6 illustrates a method for beam failure recovery according to an embodiment. The method is performed by a UE 60 and a gNB 61 in a mobile telecommunications system, e.g., by the UE 3 and the gNB 2 of the mobile telecommunications system 1 of FIG. 1.

According to the method, a ML model 62 generates candidate beam information that indicates candidate beams for beam failure recovery by the UE 60 and provides the candidate beam information to the gNB 61. At S63, the gNB 61 obtains the candidate beam information, which includes receiving the candidate beam information from the ML model 62. The ML model 62 is similar to the ML model 14 of FIG. 2, and the obtaining of the candidate beam information at S63 is similar to S15 of FIG. 2. The gNB 61 determines a selection condition for selecting a candidate beam from the candidate beam information for beam failure recovery. An example of the selection condition is the condition 40 of FIG. 4.

At S64, the gNB 61 configures the candidate beam information and the selection condition for the UE 60, which includes transmitting the candidate beam information and the selection condition to the UE 60 via RRC.

The UE 60 receives the candidate beam information and the selection condition from the gNB 61 and, at S65, configures the candidate beams indicated by the candidate beam information. The configuring at S65 includes keeping an indication of the indicated candidate beams for beam failure recovery.

At S66, the UE 60 determines a beam failure of a current serving beam and, at S67, performs beam failure recovery. For the beam failure recovery, the UE 60 selects a candidate beam from the candidate beams indicated by the candidate beam information for which the selection condition is fulfilled, and uses the selected candidate beam for the beam failure recovery.

Note that, in some embodiments, the candidate beam information includes one or more beams provided by the gNB 61 and/or one or more beams provided by another base station than the gNB 61.

Note also that the ML model 62 may be performed by a circuitry of the gNB 61 or by a circuitry of a network node in a core network of the mobile telecommunications system. Likewise, in some embodiments, the processing at S63 is performed by a circuitry of a network node in the core network instead of the gNB 61.

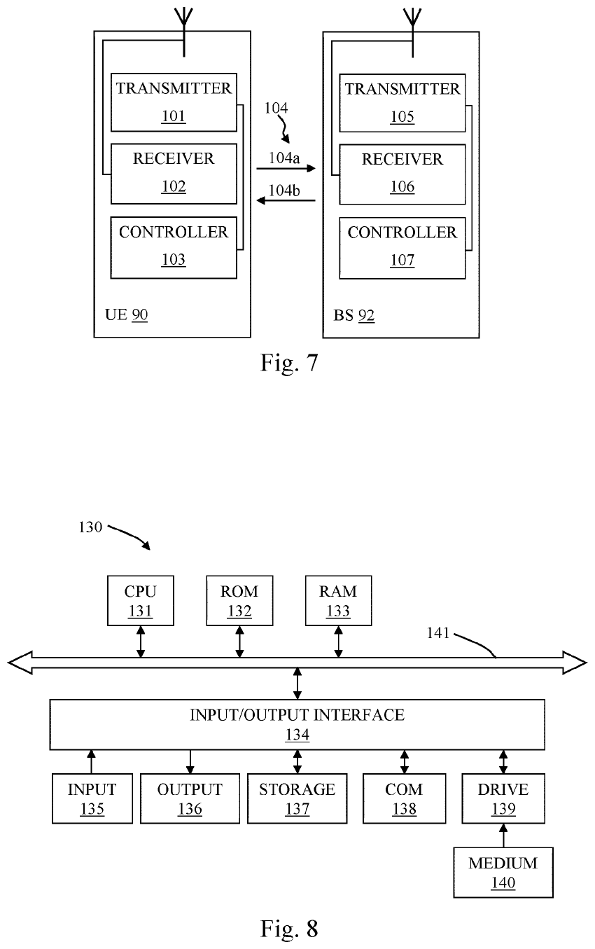

FIG. 7 illustrates a user equipment (UE) and a base station (BS) according to an embodiment.

An embodiment of a UE 90 according to the present disclosure (e.g., the UE 3 of FIG. 1, the UE 10 of FIG. 2, the UE 50 of FIG. 5 or the UE 60 of FIG. 6), a base station (BS) 92 according to the present disclosure (e.g., NR gNB such as the gNB 2 of FIG. 1, the gNB 11 of FIG. 2, the gNB 51 of FIG. 5 or the gNB 61 of FIG. 6), and a communication path 104 between the UE 90 and the BS 92, which are used for implementing embodiments of the present disclosure, is discussed under reference of FIG. 7.

The UE 90 has a transmitter 101, a receiver 102 and a controller 103, wherein, generally, the technical functionality of the transmitter 101, the receiver 102 and the controller 103 are known to the skilled person, and, thus, a more detailed description of these elements is omitted.

The BS 92 has a transmitter 105, a receiver 106 and a controller 107, wherein, generally, the technical functionality of the transmitter 105, the receiver 106 and the controller 107 are known to the skilled person, and, thus, a more detailed description of these elements is omitted.

The communication path 104 has an uplink path 104a, which is from the UE 90 to the BS 92, and a downlink path 104b, which is from the BS 92 to the UE 90. The communication path 104 includes an access link according to the present disclosure.

During operation, the controller 103 of the UE 90 controls the reception of downlink signals over the downlink path 104b at the receiver 102 and the controller 103 controls the transmission of uplink signals over the uplink path 104a via the transmitter 101.

Similarly, during operation, the controller 107 of the BS 92 controls the reception of uplink signals over the uplink path 104a and the controller 107 controls the transmission of downlink signals over the downlink path 104b.

In the following, an embodiment of a general-purpose computer 130 is described under reference of FIG. 8, which illustrates a general-purpose computer according to an embodiment.

The computer 130 can be implemented such that it can basically function as any type of user equipment, base station or new radio base station, transmission and reception point, or network node, as discussed herein. For example, the computer 130 can be configured to perform corresponding processing of the methods of FIG. 2, FIG. 3, FIG. 5 or FIG. 6 as a circuitry of a user equipment, of a base station and/or of a core network node.

The computer 130 has components 131 to 141, which can form circuitry, such as any one of the circuitries of the base station, network node and user equipment, and the like, as described herein.

Embodiments which use software, firmware, programs or the like for performing the methods as described herein can be installed on computer 130, which is then configured to be suitable for the particular embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random-access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as a base station, network node or user equipment.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, electronic ink, etc.), loudspeakers, etc.

The storage 137 can have a hard disk, a solid-state drive and the like.

The communication interface 138 can be adapted to communicate, for example, via a local area network (LAN), wireless local area network (WLAN), mobile telecommunications system (GSM, UMTS, LTE, NR etc.), Bluetooth, infrared, near-field communication (NFC), etc.

It should be noted that the description above only pertains to an example configuration of computer 130. Alternative configurations may be implemented with additional or other sensors, storage devices, interfaces or the like. For example, the communication interface 138 may support other radio access technologies than UMTS, LTE and NR, or the like.

When the computer 130 functions as a base station, the communication interface 138 can further have a respective air interface (providing, e.g., E-UTRA protocols OFDMA (downlink) and SC-FDMA (uplink)) and network interfaces (implementing for example protocols such as S1-AP, GTP-U, S1-MME, X2-AP, or the like). The computer 130 is also implemented to transmit data in accordance with TCP. Moreover, the computer 130 may have one or more antennas and/or an antenna array. The present disclosure is not limited to any particularities of such protocols.

It should be recognized that the embodiments describe methods with an exemplary ordering of method steps. The specific ordering of method steps is however given for illustrative purposes only and should not be construed as binding. Suitable changes of the ordering of method steps may be apparent to the skilled person.

Please note that the division of the UE 90 into units 101 to 103 and of the BS 92 into units 105 to 107 is only made for illustration purposes and that the present disclosure is not limited to any specific division of functions in specific units. For instance, the UE 90 and/or the BS 92 could be implemented by a respective programmed processor, field programmable gate array (FPGA) and the like.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(A1) A base station for a mobile telecommunications system, wherein the base station comprises circuitry configured to:
   obtain candidate beam information for a user equipment of the mobile telecommunications system, wherein the candidate beam information is generated by a machine learning model and indicates a candidate beam for beam level mobility of the user equipment; and
   configure the candidate beam for communication with the user equipment according to the candidate beam information.
(A2) The base station of (A1),
   wherein the configuring of the candidate beam includes configuring a simultaneous transmission configuration indicator update list of a list of cells of the mobile telecommunications system with which the candidate beam is associated within a cell group configuration using a radio resource control reconfiguration message.
(A3) The base station of (A1) or (A2),
   wherein the configuring of the candidate beam includes configuring a physical downlink shared channel transmission configuration indicator that is associated with the candidate beam in a transmission configuration indicator information of a serving cell configuration with a radio resource control reconfiguration message.
(A4) The base station of any one of (A1) to (A3),
   wherein the circuitry is provided on a network side of the mobile telecommunications system.
(A5) the base station of any one of (A1) to (A4),
   wherein the machine learning model is evaluated by the user equipment; and
   wherein the obtaining of the candidate beam information includes receiving the candidate beam information from the user equipment.
(A6) The base station of any one of (A1) to (A4),
   wherein the machine learning model is evaluated on a network side of the mobile telecommunications system.
(A7) The base station of (A6), wherein the circuitry is configured to:
   receive a measurement report from the user equipment;
   obtain the candidate beam information by generating, by the machine learning model, the candidate beam information based on the received measurement report; and
   transmit to the user equipment a deactivation signal that instructs the user equipment to skip sending a measurement report.
(A8) The base station of (A7),
   wherein the deactivation signal is based on a physical layer signaling.
(A9) The base station of (A7) or (A8),
   wherein the deactivation signal is included in Downlink Control Information.
(A10) The base station of any one of (A7) to (A9),
   wherein the circuitry is configured to transmit the deactivation signal if the circuitry decides that the received measurement report is sufficient for generating a future candidate beam information.
(A11) The base station of any one of (A7) to (A10),
   wherein the circuitry is configured to transmit the deactivation signal if a probability of a beam level switch of the user equipment is estimated to be low based on a mobility status of the user equipment.
(A12) The base station of any one of (A7) to (A11),
   wherein the circuitry is further configured to transmit to the user equipment an activation signal that instructs the user equipment to resume sending a measurement report.
(A13) The base station of any one of (A7) to (A12),
   wherein the deactivation signal instructs the user equipment to skip sending a measurement report for a predefined number of measurement cycles.
(A14) the base station of any one of (A7) to (A12),
   wherein the deactivation signal instructs the user equipment to skip sending a measurement report for a predefined time period.
(A15) The base station of any one of (A7) to (A14),
   wherein the measurement report indicates a reference signal received power of a physical channel on which the user equipment receives a beam.
(A16) the base station of any one of (A1) to (A15),
   wherein the configuring of the candidate beam includes configuring a switching condition for switching to the candidate beam.
(A17) the base station of (A16),
   wherein the switching condition indicates switching to the candidate beam if a beam quality of a serving beam is below a predefined threshold.
(A18) The base station of (A16) or (A17),
   wherein the switching condition indicates switching to the candidate beam if a beam quality of the candidate beam exceeds a predefined threshold.
(A19) The base station of any one of (A16) to (A18),
   wherein the switching condition indicates a time duration after which switching to the candidate beam based on the candidate beam information is not allowed anymore.
(A20) The base station of (A19),
   wherein the time duration is based on the machine learning model.
(A21) The base station of (A19) or (A20),
   wherein the time duration is based on an averaging time duration for a measuring result filtering performed by the user equipment.
(A22) The base station of any one of (A16) to (A21),
   wherein the configuring of the switching condition includes transmitting the switching condition in a Media Access Control Control Element to the user equipment.
(A23) The base station of any one of (A16) to (A21),
   wherein the configuring of the switching condition includes transmitting the switching condition in Downlink Control Information to the user equipment.
(A24) The base station of (A22) or (A23),
   wherein the configuring of the candidate beam includes:
      transmitting the candidate beam information based on Radio Resource Control signaling to the user equipment; and
      transmitting the switching condition after transmitting the candidate beam information.
(A25) The base station of any one of (A16) to (A24),
   wherein the configuring of the candidate beam includes configuring a plurality of candidate beams for the user equipment; and
   wherein the switching condition indicates an associated priority for respective ones of the plurality of candidate beams.
(A26) The base station of (A25),
   wherein the associated priority is based on an inference result of the machine learning model.
(A27) the base station of (a25) or (A26),
   wherein the associated priority is based on a predicted link quality of the respective candidate beams within a certain time range.
(A28) The base station of any one of (A25) to (A27),
   wherein the associated priority is based on a link quality evolution trend of the respective candidate beams.
(A29) The base station of any one of (A25) to (A28),
   wherein the associated priority is based on service characteristics requirements of the user equipment.
(A30) The base station of any one of (A16) to (A29),
   wherein the configuring of the candidate beam includes configuring a plurality of candidate beams for the user equipment in a time order and a switching condition for respective ones of the plurality of candidate beams.
(B1) A user equipment for a mobile telecommunications system, wherein the user equipment comprises circuitry configured to:
   obtain candidate beam information for the user equipment, wherein the candidate beam information is generated by a machine learning model and indicates a candidate beam for beam level mobility of the user equipment; and
   configure the candidate beam for communication with a base station of the mobile telecommunications system according to the candidate beam information.
(B2) the user equipment of (B1),
   wherein the configuring of the candidate beam includes configuring a simultaneous transmission configuration indicator update list of a list of cells of the mobile telecommunications system with which the candidate beam is associated within a cell group configuration based on a radio resource control reconfiguration message.
(B3) The user equipment of (B1) or (B2),
   wherein the configuring of the candidate beam includes configuring a physical downlink shared channel transmission configuration indicator that is associated with the candidate beam in a transmission configuration indicator information of a serving cell configuration based on a radio resource control reconfiguration message.
(B4) The user equipment of any one of (B1) to (B3),
   wherein the base station is provided on a network side of the mobile telecommunications system.
(B5) The user equipment of any one of (B1) to (B4),
   wherein the obtaining of the candidate beam information includes evaluating the machine learning model.
(B6) The user equipment of any one of (B1) to (B4),
   wherein the machine learning model is evaluated on a network side of the mobile telecommunications system; and
   wherein the obtaining of the candidate beam information includes receiving the candidate beam information from the base station.
(B7) The user equipment of (B6), wherein the circuitry is configured to:
   transmit a measurement report to the base station for generating the candidate beam information based on the measurement report;
   receive from the base station a deactivation signal that instructs the user equipment to skip sending a measurement report; and
   skip sending a measurement report according to the deactivation signal.
(B8) The user equipment of (B7),
   wherein the deactivation signal is based on a physical layer signaling.
(B9) The user equipment of (B7) or (B8),
   wherein the deactivation signal is included in Downlink Control Information.
(B10) the user equipment of any one of (B7) to (B9),
   wherein the circuitry is configured to receive the deactivation signal if the network decides that the transmitted measurement report is sufficient for generating a future candidate beam information.
(B11) The user equipment of any one of (B7) to (B10),
   wherein the circuitry is configured to receive the deactivation signal if a probability of a beam level switch of the user equipment is estimated to be low based on a mobility status of the user equipment.
(B12) The user equipment of any one of (B7) to (B11), wherein the circuitry is further configured to:
   receive from the base station an activation signal that instructs the user equipment to resume sending a measurement report; and
   resume sending a measurement report according to the activation signal.
(B13) The user equipment of any one of (B7) to (B12),
   wherein the deactivation signal instructs the user equipment to skip sending a measurement report for a predefined number of measurement cycles.
(B14) The user equipment of any one of (B7) to (B12),
   wherein the deactivation signal instructs the user equipment to skip sending a measurement report for a predefined time period.
(B15) The user equipment of any one of (B7) to (B14),
   wherein the measurement report indicates a reference signal received power of a physical channel on which the user equipment receives a beam.
(B16) The user equipment of any one of (B1) to (B15),
   wherein the configuring of the candidate beam includes configuring a switching condition for switching to the candidate beam.
(B17) The user equipment of (B16),
   wherein the switching condition indicates switching to the candidate beam if a beam quality of a serving beam is below a predefined threshold.
(B18) The user equipment of (B16) or (B17),
   wherein the switching condition indicates switching to the candidate beam if a beam quality of the candidate beam exceeds a predefined threshold.
(B19) The user equipment of any one of (B16) to (B18),
   wherein the switching condition indicates a time duration after which switching to the candidate beam based on the candidate beam information is not allowed anymore.
(B20) The user equipment of (B19),
   wherein the time duration is based on the machine learning model.
(B21) The user equipment of (B19) or (B20),
   wherein the time duration is based on an averaging time duration for a measuring result filtering performed by the user equipment.
(B22) The user equipment of any one of (B16) to (B21),
   wherein the obtaining of the candidate beam information includes receiving the switching condition in a Media Access Control Control Element from the base station.
(B23) The user equipment of any one of (B16) to (B21),
   wherein the obtaining of the candidate beam information includes receiving the switching condition in Downlink Control Information from the base station.
(B24) The user equipment of (B22) or (B23),
   wherein the obtaining of the candidate beam information includes:
      receiving the candidate beam information based on Radio Resource Control signaling from the base station; and
      receiving the switching condition after receiving the candidate beam information.
(B25) The user equipment of any one of (B16) to (B24),
   wherein the configuring of the candidate beam includes configuring a plurality of candidate beams for the user equipment; and
   wherein the switching condition indicates an associated priority for respective ones of the plurality of candidate beams.
(B26) the user equipment of (B25),
   wherein the associated priority is based on an inference result of the machine learning model.
(B27) The user equipment of (B25) or (B26),
   wherein the associated priority is based on a predicted link quality of the respective candidate beams within a certain time range.
(B28) The user equipment of any one of (B25) to (B27),
   wherein the associated priority is based on a link quality evolution trend of the respective candidate beams.
(B29) The user equipment of any one of (B25) to (B28),
   wherein the associated priority is based on service characteristics requirements of the user equipment.
(B30) The user equipment of any one of (B16) to (B29),
   wherein the configuring of the candidate beam includes configuring a plurality of candidate beams for the user equipment in a time order and a switching condition for respective ones of the plurality of candidate beams.
(C1) A circuitry for a mobile telecommunications system, wherein the circuitry is configured to:
   obtain candidate beam information for a user equipment of the mobile telecommunications system, wherein the candidate beam information is generated by a machine learning model and indicates a candidate beam for beam level mobility of the user equipment; and
   configure the candidate beam for communication with the user equipment according to the candidate beam information.
(C2) The circuitry of (C1),
   wherein the configuring of the candidate beam includes configuring a simultaneous transmission configuration indicator update list of a list of cells of the mobile telecommunications system with which the candidate beam is associated within a cell group configuration using a radio resource control reconfiguration message.
(C3) the circuitry of (C1) or (C2),
   wherein the configuring of the candidate beam includes configuring a physical downlink shared channel transmission configuration indicator that is associated with the candidate beam in a transmission configuration indicator information of a serving cell configuration with a radio resource control reconfiguration message.
(C4) the circuitry of any one of (C1) to (C3),
   wherein the circuitry is provided on a network side of the mobile telecommunications system.
(C5) the circuitry of any one of (C1) to (C4),
   wherein the machine learning model is evaluated by the user equipment; and
   wherein the obtaining of the candidate beam information includes receiving the candidate beam information from the user equipment.
(C6) The circuitry of any one of (C1) to (C4),
   wherein the machine learning model is evaluated on a network side of the mobile telecommunications system.
(C7) The circuitry of (C6), wherein the circuitry is configured to:
   receive a measurement report from the user equipment;
   obtain the candidate beam information by generating, by the machine learning model, the candidate beam information based on the received measurement report; and
   transmit to the user equipment a deactivation signal that instructs the user equipment to skip sending a measurement report.
(C8) the circuitry of (C7),
   wherein the deactivation signal is based on a physical layer signaling.
(C9) The circuitry of (C7) or (C8),
   wherein the deactivation signal is included in Downlink Control Information.
(C10) The circuitry of any one of (C7) to (C9),
   wherein the circuitry is configured to transmit the deactivation signal if the circuitry decides that the received measurement report is sufficient for generating a future candidate beam information.
(C11) The circuitry of any one of (C7) to (C10),
   wherein the circuitry is configured to transmit the deactivation signal if a probability of a beam level switch of the user equipment is estimated to be low based on a mobility status of the user equipment.
(C12) The circuitry of any one of (C7) to (C11),
   wherein the circuitry is further configured to transmit to the user equipment an activation signal that instructs the user equipment to resume sending a measurement report.
(C13) The circuitry of any one of (C7) to (C12),
   wherein the deactivation signal instructs the user equipment to skip sending a measurement report for a predefined number of measurement cycles.
(C14) the circuitry of any one of (C7) to (C12),
   wherein the deactivation signal instructs the user equipment to skip sending a measurement report for a predefined time period.
(C15) The circuitry of any one of (C7) to (C14),
   wherein the measurement report indicates a reference signal received power of a physical channel on which the user equipment receives a beam.
(C16) the circuitry of any one of (C1) to (C15),
   wherein the configuring of the candidate beam includes configuring a switching condition for switching to the candidate beam.
(C17) the circuitry of (C16),
   wherein the switching condition indicates switching to the candidate beam if a beam quality of a serving beam is below a predefined threshold.
(C18) The circuitry of (C16) or (C17),
   wherein the switching condition indicates switching to the candidate beam if a beam quality of the candidate beam exceeds a predefined threshold.
(C19) The circuitry of any one of (C16) to (C18),
   wherein the switching condition indicates a time duration after which switching to the candidate beam based on the candidate beam information is not allowed anymore.
(C20) The circuitry of (C19),
   wherein the time duration is based on the machine learning model.
(C21) The circuitry of (C19) or (C20),
   wherein the time duration is based on an averaging time duration for a measuring result filtering performed by the user equipment.
(C22) The circuitry of any one of (C16) to (C21),
   wherein the configuring of the switching condition includes transmitting the switching condition in a Media Access Control Control Element to the user equipment.
(C23) The circuitry of any one of (C16) to (C21),
   wherein the configuring of the switching condition includes transmitting the switching condition in Downlink Control Information to the user equipment.
(C24) The circuitry of (C22) or (C23),
   wherein the configuring of the candidate beam includes:
      transmitting the candidate beam information based on Radio Resource Control signaling to the user equipment; and
      transmitting the switching condition after transmitting the candidate beam information.
(C25) The circuitry of any one of (C16) to (C24),
   wherein the configuring of the candidate beam includes configuring a plurality of candidate beams for the user equipment; and
   wherein the switching condition indicates an associated priority for respective ones of the plurality of candidate beams.
(C26) The circuitry of (C25),
   wherein the associated priority is based on an inference result of the machine learning model.
(C27) the circuitry of (C25) or (C26),
   wherein the associated priority is based on a predicted link quality of the respective candidate beams within a certain time range.
(C28) The circuitry of any one of (C25) to (C27),
   wherein the associated priority is based on a link quality evolution trend of the respective candidate beams.
(C29) The circuitry of any one of (C25) to (C28),
   wherein the associated priority is based on service characteristics requirements of the user equipment.
(C30) The circuitry of any one of (C16) to (C29),
   wherein the configuring of the candidate beam includes configuring a plurality of candidate beams for the user equipment in a time order and a switching condition for respective ones of the plurality of candidate beams.
(D1) A method for a mobile telecommunications system, the method comprising:
   obtaining candidate beam information for a user equipment of the mobile telecommunications system, wherein the candidate beam information is generated by a machine learning model and indicates a candidate beam for beam level mobility of the user equipment; and
   configuring the candidate beam for communication with the user equipment according to the candidate beam information.
(D2) the method of (D1),
   wherein the configuring of the candidate beam includes configuring a simultaneous transmission configuration indicator update list of a list of cells of the mobile telecommunications system with which the candidate beam is associated within a cell group configuration using a radio resource control reconfiguration message.
(D3) the method of (D1) or (D2),
   wherein the configuring of the candidate beam includes configuring a physical downlink shared channel transmission configuration indicator that is associated with the candidate beam in a transmission configuration indicator information of a serving cell configuration with a radio resource control reconfiguration message.
(D4) The method of any one of (D1) to (D3),
   wherein the method is performed by a network of the mobile telecommunications system.
(D5) The method of any one of (D1) to (D4),
   wherein the machine learning model is evaluated by the user equipment; and
   wherein the obtaining of the candidate beam information includes receiving the candidate beam information from the user equipment.
(D6) the method of any one of (D1) to (D4),
   wherein the machine learning model is evaluated on a network side of the mobile telecommunications system.
(D7) The method of (D6), comprising:
   receiving a measurement report from the user equipment;
   obtaining the candidate beam information by generating, by the machine learning model, the candidate beam information based on the received measurement report; and
   transmitting to the user equipment a deactivation signal that instructs the user equipment to skip sending a measurement report.
(D8) the method of (D7),
   wherein the deactivation signal is based on a physical layer signaling.
(D9) The method of (D7) or (D8),
   wherein the deactivation signal is included in Downlink Control Information.
(D10) The method of any one of (D7) to (D9),
   wherein the method comprises transmitting the deactivation signal if it is decided that the received measurement report is sufficient for generating a future candidate beam information.
(D11) the method of any one of (D7) to (D10),
   wherein the method comprises transmitting the deactivation signal if a probability of a beam level switch of the user equipment is estimated to be low based on a mobility status of the user equipment.
(D12) The method of any one of (D7) to (D11),
   wherein the method further comprises transmitting to the user equipment an activation signal that instructs the user equipment to resume sending a measurement report.
(D13) The method of any one of (D7) to (D12),
   wherein the deactivation signal instructs the user equipment to skip sending a measurement report for a predefined number of measurement cycles.
(D14) The method of any one of (D7) to (D12),
   wherein the deactivation signal instructs the user equipment to skip sending a measurement report for a predefined time period.
(D15) the method of any one of (D7) to (D14),
   wherein the measurement report indicates a reference signal received power of a physical channel on which the user equipment receives a beam.
(D16) the method of any one of (D1) to (D15),
   wherein the configuring of the candidate beam includes configuring a switching condition for switching to the candidate beam.
(D17) the method of (D16),
   wherein the switching condition indicates switching to the candidate beam if a beam quality of a serving beam is below a predefined threshold.
(D18) The method of (D16) or (D17),
   wherein the switching condition indicates switching to the candidate beam if a beam quality of the candidate beam exceeds a predefined threshold.
(D19) The method of any one of (D16) to (D18),
   wherein the switching condition indicates a time duration after which switching to the candidate beam based on the candidate beam information is not allowed anymore.
(D20) The method of (D19),
   wherein the time duration is based on the machine learning model.
(D21) the method of (D19) or (D20),
   wherein the time duration is based on an averaging time duration for a measuring result filtering performed by the user equipment.
(D22) The method of any one of (D16) to (D21),
   wherein the configuring of the switching condition includes transmitting the switching condition in a Media Access Control Control Element to the user equipment.
(D23) The method of any one of (D16) to (D21),
   wherein the configuring of the switching condition includes transmitting the switching condition in Downlink Control Information to the user equipment.
(D24) the method of (D22) or (D23),
   wherein the configuring of the candidate beam includes:
      transmitting the candidate beam information based on Radio Resource Control signaling to the user equipment; and
      transmitting the switching condition after transmitting the candidate beam information.
(D25) The method of any one of (D16) to (D24),
   wherein the configuring of the candidate beam includes configuring a plurality of candidate beams for the user equipment; and
   wherein the switching condition indicates an associated priority for respective ones of the plurality of candidate beams.
(D26) the method of (D25),
   wherein the associated priority is based on an inference result of the machine learning model.
(D27) the method of (D25) or (D26),
   wherein the associated priority is based on a predicted link quality of the respective candidate beams within a certain time range.
(D28) The method of any one of (D25) to (D27),
   wherein the associated priority is based on a link quality evolution trend of the respective candidate beams.
(D29) the method of any one of (D25) to (D28),
   wherein the associated priority is based on service characteristics requirements of the user equipment.
(D30) the method of any one of (D16) to (D29),
   wherein the configuring of the candidate beam includes configuring a plurality of candidate beams for the user equipment in a time order and a switching condition for respective ones of the plurality of candidate beams.
(E1) A method for a user equipment of a mobile telecommunications system, wherein the method comprises:
   obtaining candidate beam information for the user equipment, wherein the candidate beam information is generated by a machine learning model and indicates a candidate beam for beam level mobility of the user equipment; and
   configuring the candidate beam for communication with a base station of the mobile telecommunications system according to the candidate beam information.
(E2) The method of (E1),
   wherein the configuring of the candidate beam includes configuring a simultaneous transmission configuration indicator update list of a list of cells of the mobile telecommunications system with which the candidate beam is associated within a cell group configuration based on a radio resource control reconfiguration message.
(E3) the method of (E1) or (E2),
   wherein the configuring of the candidate beam includes configuring a physical downlink shared channel transmission configuration indicator that is associated with the candidate beam in a transmission configuration indicator information of a serving cell configuration based on a radio resource control reconfiguration message.
(E4) the method of any one of (E1) to (E3),
   wherein the base station is provided on a network side of the mobile telecommunications system.
(E5) The method of any one of (E1) to (E4),
   wherein the obtaining of the candidate beam information includes evaluating the machine learning model.
(E6) The method of any one of (E1) to (E4),
   wherein the machine learning model is evaluated on a network side of the mobile telecommunications system; and
   wherein the obtaining of the candidate beam information includes receiving the candidate beam information from the base station.
(E7) the method of (E6), comprising:
   transmitting a measurement report to the base station for generating the candidate beam information based on the measurement report;
   receiving from the base station a deactivation signal that instructs the user equipment to skip sending a measurement report; and
   skipping sending a measurement report according to the deactivation signal.
(E8) The method of (E7),
   wherein the deactivation signal is based on a physical layer signaling.
(E9) The method of (E7) or (E8),
   wherein the deactivation signal is included in Downlink Control Information.
(E10) The method of any one of (E7) to (E9),
   wherein the method comprises receiving the deactivation signal if the network decides that the transmitted measurement report is sufficient for generating a future candidate beam information.
(E11) The method of any one of (E7) to (E10),
   wherein the method comprises receiving the deactivation signal if a probability of a beam level switch of the user equipment is estimated to be low based on a mobility status of the user equipment.
(E12) The method of any one of (E7) to (E11), wherein the method further comprises:
   receiving from the base station an activation signal that instructs the user equipment to resume sending a measurement report; and
   resuming sending a measurement report according to the activation signal.
(E13) The method of any one of (E7) to (E12),
   wherein the deactivation signal instructs the user equipment to skip sending a measurement report for a predefined number of measurement cycles.
(E14) The method of any one of (E7) to (E12),
   wherein the deactivation signal instructs the user equipment to skip sending a measurement report for a predefined time period.
(E15) the method of any one of (E7) to (E14),
   wherein the measurement report indicates a reference signal received power of a physical channel on which the user equipment receives a beam.
(E16) the method of any one of (E1) to (E15),
   wherein the configuring of the candidate beam includes configuring a switching condition for switching to the candidate beam.
(E17) The method of (E16),
   wherein the switching condition indicates switching to the candidate beam if a beam quality of a serving beam is below a predefined threshold.
(E18) the method of (E16) or (E17),
   wherein the switching condition indicates switching to the candidate beam if a beam quality of the candidate beam exceeds a predefined threshold.
(E19) The method of any one of (E16) to (E18),
   wherein the switching condition indicates a time duration after which switching to the candidate beam based on the candidate beam information is not allowed anymore.
(E20) The method of (E19),
   wherein the time duration is based on the machine learning model.
(E21) The method of (E19) or (E20),
   wherein the time duration is based on an averaging time duration for a measuring result filtering performed by the user equipment.
(E22) The method of any one of (E16) to (E21),
   wherein the obtaining of the candidate beam information includes receiving the switching condition in a Media Access Control Control Element from the base station.
(E23) The method of any one of (E16) to (E21),
   wherein the obtaining of the candidate beam information includes receiving the switching condition in Downlink Control Information from the base station.
(E24) The method of (E22) or (E23),
   wherein the obtaining of the candidate beam information includes:
      receiving the candidate beam information based on Radio Resource Control signaling from the base station; and
      receiving the switching condition after receiving the candidate beam information.
(E25) The method of any one of (E16) to (E24),
   wherein the configuring of the candidate beam includes configuring a plurality of candidate beams for the user equipment; and
   wherein the switching condition indicates an associated priority for respective ones of the plurality of candidate beams.
(E26) The method of (E25),
   wherein the associated priority is based on an inference result of the machine learning model.
(E27) The method of (E25) or (E26),
   wherein the associated priority is based on a predicted link quality of the respective candidate beams within a certain time range.
(E28) The method of any one of (E25) to (E27),
   wherein the associated priority is based on a link quality evolution trend of the respective candidate beams.
(E29) the method of any one of (E25) to (E28),
   wherein the associated priority is based on service characteristics requirements of the user equipment.
(E30) The method of any one of (E26) to (E29),
   wherein the configuring of the candidate beam includes configuring a plurality of candidate beams for the user equipment in a time order and a switching condition for respective ones of the plurality of candidate beams.
(F1) A computer program comprising program code causing a computer to perform the method according to anyone of (D1) to (E30), when being carried out on a computer.
(F2) A non-transitory computer-readable recording medium that stores therein a computer program product, which, when executed by a processor, causes the method according to anyone of (D1) to (E30) to be performed.
(G1) A base station for a mobile telecommunications system, wherein the base station comprises circuitry configured to:
   receive a measurement report from a user equipment of the mobile telecommunications system;
   generate, by a machine learning model, candidate beam information for the user equipment, wherein the candidate beam information indicates a candidate beam for beam level mobility of the user equipment and is based on the received measurement report; and
   transmit to the user equipment a deactivation signal that instructs the user equipment to skip sending a measurement report.
(G2) The base station of (G1),
   wherein the deactivation signal is based on a physical layer signaling.
(G3) The base station of (G1) or (G2),
   wherein the deactivation signal is included in Downlink Control Information.
(G4) The base station of any one of (G1) to (G3),
   wherein the circuitry is configured to transmit the deactivation signal if the circuitry decides that the received measurement report is sufficient for generating a future candidate beam information.
(G5) The base station of any one of (G1) to (G4),
   wherein the circuitry is configured to transmit the deactivation signal if a probability of a beam level switch of the user equipment is estimated to be low based on a mobility status of the user equipment.
(G6) The base station of any one of (G1) to (G5),
   wherein the circuitry is further configured to transmit to the user equipment an activation signal that instructs the user equipment to resume sending a measurement report.
(G7) The base station of any one of (G1) to (G6),
   wherein the deactivation signal instructs the user equipment to skip sending a measurement report for a predefined number of measurement cycles.
(G8) The base station of any one of (G1) to (G6),
   wherein the deactivation signal instructs the user equipment to skip sending a measurement report for a predefined time period.
(G9) The base station of any one of (G1) to (G8),
   wherein the measurement report indicates a reference signal received power of a physical channel on which the user equipment receives a beam.
(H1) A user equipment for a mobile telecommunications system, wherein the user equipment comprises circuitry configured to:
   transmit a measurement report to a base station of the mobile telecommunications system for generating, by a machine learning model evaluated on a network side of the mobile telecommunications system, candidate beam information for the user equipment, wherein the candidate beam information indicates a candidate beam for beam level mobility of the user equipment and is based on the received measurement report;
   receive from the base station a deactivation signal that instructs the user equipment to skip sending a measurement report; and
   skip sending a measurement report according to the deactivation signal.
(H2) The user equipment of (H1),
   wherein the deactivation signal is based on a physical layer signaling.
(H3) The user equipment of (H1) or (H2),
   wherein the deactivation signal is included in Downlink Control Information.
(H4) The user equipment of any one of (H1) to (H3),
   wherein the circuitry is configured to receive the deactivation signal if the network decides that the received measurement report is sufficient for generating a future candidate beam information.
(H5) The user equipment of any one of (H1) to (H4),
   wherein the circuitry is configured to receive the deactivation signal if a probability of a beam level switch of the user equipment is estimated to be low based on a mobility status of the user equipment.
(H6) The user equipment of any one of (H1) to (H5), wherein the circuitry is further configured to:
   receive from the base station an activation signal that instructs the user equipment to resume sending a measurement report; and
   resume sending a measurement report according to the activation signal.
(H7) The user equipment of any one of (H1) to (H6),
   wherein the deactivation signal instructs the user equipment to skip sending a measurement report for a predefined number of measurement cycles.
(H8) The user equipment of any one of (H1) to (H6),
   wherein the deactivation signal instructs the user equipment to skip sending a measurement report for a predefined time period.
(H9) The user equipment of any one of (H1) to (H8),
   wherein the measurement report indicates a reference signal received power of a physical channel on which the user equipment receives a beam.
(I1) A circuitry for a mobile telecommunications system, wherein the circuitry is configured to:
   receive a measurement report from a user equipment of the mobile telecommunications
   generate, by a machine learning model, candidate beam information for the user equipment, wherein the candidate beam information indicates a candidate beam for beam level mobility of the user equipment and is based on the received measurement report; and
   transmit to the user equipment a deactivation signal that instructs the user equipment to skip sending a measurement report.
(I2) the circuitry of (I1),
   wherein the deactivation signal is based on a physical layer signaling.
(I3) The circuitry of (I1) or (I2),
   wherein the deactivation signal is included in Downlink Control Information.
(I4) The circuitry of any one of (I1) to (I3),
   wherein the circuitry is configured to transmit the deactivation signal if the circuitry decides that the received measurement report is sufficient for generating a future candidate beam information.
(I5) The circuitry of any one of (I1) to (I4),
   wherein the circuitry is configured to transmit the deactivation signal if a probability of a beam level switch of the user equipment is estimated to be low based on a mobility status of the user equipment.
(I6) The circuitry of any one of (I1) to (I5),
   wherein the circuitry is further configured to transmit to the user equipment an activation signal that instructs the user equipment to resume sending a measurement report.
(I7) The circuitry of any one of (I1) to (I6),
   wherein the deactivation signal instructs the user equipment to skip sending a measurement report for a predefined number of measurement cycles.
(I8) The circuitry of any one of (I1) to (I6),
   wherein the deactivation signal instructs the user equipment to skip sending a measurement report for a predefined time period.
(I9) The circuitry of any one of (I1) to (I8),
   wherein the measurement report indicates a reference signal received power of a physical channel on which the user equipment receives a beam.
(J1) A method for a mobile telecommunications system, wherein the method comprises:
   receiving a measurement report from a user equipment of the mobile telecommunications system;
   generating, by a machine learning model, candidate beam information for the user equipment, wherein the candidate beam information indicates a candidate beam for beam level mobility of the user equipment and is based on the received measurement report; and
   transmitting to the user equipment a deactivation signal that instructs the user equipment to skip sending a measurement report.
(J2) the method of (J1),
   wherein the deactivation signal is based on a physical layer signaling.
(J3) The method of (J1) or (J2),
   wherein the deactivation signal is included in Downlink Control Information.
(J4) The method of any one of (J1) to (J3),
   wherein the method comprises transmitting the deactivation signal if it is decided that the received measurement report is sufficient for generating a future candidate beam information.
(J5) The method of any one of (J1) to (J4),
   wherein the method comprises transmitting the deactivation signal if a probability of a beam level switch of the user equipment is estimated to be low based on a mobility status of the user equipment.
(J6) The method of any one of (J1) to (J5),
   wherein the method further comprises transmitting to the user equipment an activation signal that instructs the user equipment to resume sending a measurement report.
(J7) The method of any one of (J1) to (J6),
   wherein the deactivation signal instructs the user equipment to skip sending a measurement report for a predefined number of measurement cycles.
(J8) The method of any one of (J1) to (J6),
   wherein the deactivation signal instructs the user equipment to skip sending a measurement report for a predefined time period.
(J9) The method of any one of (J1) to (J8),
   wherein the measurement report indicates a reference signal received power of a physical channel on which the user equipment receives a beam.
(K1) A method for a user equipment of a mobile telecommunications system, wherein the method comprises:
   transmitting a measurement report to a base station of the mobile telecommunications system for generating, by a machine learning model evaluated on a network side of the mobile telecommunications system, candidate beam information for the user equipment, wherein the candidate beam information indicates a candidate beam for beam level mobility of the user equipment and is based on the received measurement report;
   receiving from the base station a deactivation signal that instructs the user equipment to skip sending a measurement report; and
   skipping sending a measurement report according to the deactivation signal.
(K2) The method of (K1),
   wherein the deactivation signal is based on a physical layer signaling.
(K3) The method of (K1) or (K2),
   wherein the deactivation signal is included in Downlink Control Information.
(K4) The method of any one of (K1) to (K3),
   wherein the method comprises receiving the deactivation signal if the network decides that the received measurement report is sufficient for generating a future candidate beam information.
(K5) The method of any one of (K1) to (K4),
   wherein the method comprises receiving the deactivation signal if a probability of a beam level switch of the user equipment is estimated to be low based on a mobility status of the user equipment.
(K6) The method of any one of (K1) to (K5), further comprising:
   receiving from the base station an activation signal that instructs the user equipment to resume sending a measurement report; and resuming sending a measurement report according to the activation signal.
(K7) The method of any one of (K1) to (K6),
   wherein the deactivation signal instructs the user equipment to skip sending a measurement report for a predefined number of measurement cycles.
(K8) The method of any one of (K1) to (K6),
   wherein the deactivation signal instructs the user equipment to skip sending a measurement report for a predefined time period.
(K9) the method of any one of (K1) to (K8),
   wherein the measurement report indicates a reference signal received power of a physical channel on which the user equipment receives a beam.
(L1) A computer program comprising program code causing a computer to perform the method according to anyone of (J1) to (K9), when being carried out on a computer.
(L2) A non-transitory computer-readable recording medium that stores therein a computer program product, which, when executed by a processor, causes the method according to anyone of (J1) to (K9) to be performed.
(M1) A base station for a mobile telecommunications system, wherein the base station comprises circuitry configured to:
   obtain, from a machine learning model, candidate beam information for a user equipment of the mobile telecommunications system, wherein the candidate beam information indicates a plurality of candidate beams for beam failure recovery of the user equipment; and
   configure the plurality of candidate beams for the user equipment and a selection condition for selecting a candidate beam of the plurality of candidate beams for beam failure recovery.
(M2) The base station of (M1),
   wherein the selection condition indicates different respective beam quality thresholds for at least two candidate beams of the plurality of candidate beams according to an inference result of the machine learning model.
(M3) the base station of (M2),
   wherein the beam quality thresholds relate to a reference signal received power of the respective candidate beams.
(M4) The base station of any one of (M1) to (M3),
   wherein the circuitry is configured to transmit the candidate beam information to the user equipment.
(M5) The base station of any one of (M1) to (M4),
   wherein the selection condition indicates time information for a candidate beam of the plurality of candidate beams according to an inference result of the machine learning model.
(M6) The base station of any one of (M1) to (M5),
   wherein the selection condition indicates a predicted link quality in a future time for a candidate beam of the plurality of candidate beams according to an inference result of the machine learning model.
(M7) the base station of any one of (M1) to (M6),
   wherein the selection condition indicates an associated priority for respective ones of the plurality of candidate beams.
(M8) The base station of (M7),
   wherein the associated priority is based on an inference result of the machine learning model.
(M9) the base station of (M7) or (M8),
   wherein the associated priority is based on a predicted link quality of the respective candidate beams within a certain time range.
(M10) The base station of any one of (M7) to (M9),
   wherein the associated priority is based on a link quality evolution trend of the respective candidate beams.
(M11) The base station of any one of (M7) to (M10),
   wherein the associated priority is based on service characteristics requirements of the user equipment.
(N1) A user equipment for a mobile telecommunications system, wherein the user equipment comprises circuitry configured to:
   obtain, from a machine learning model, candidate beam information for the user equipment, wherein the candidate beam information indicates a plurality of candidate beams for beam failure recovery of the user equipment; and
   configure the plurality of candidate beams for communication with a base station of the mobile telecommunication system and a selection condition for selecting a candidate beam of the plurality of candidate beams for beam failure recovery.
(N2) The user equipment of (N1),
   wherein the selection condition indicates different respective beam quality thresholds for at least two candidate beams of the plurality of candidate beams according to an inference result of the machine learning model.
(N3) the user equipment of (N2),
   wherein the beam quality thresholds relate to a reference signal received power of the respective candidate beams.
(N4) the user equipment of any one of (N1) to (N3),
   wherein the obtaining of the candidate beam information includes receiving the candidate beam information from the base station.
(N5) The user equipment of any one of (N1) to (N4),
   wherein the selection condition indicates time information for a candidate beam of the plurality of candidate beams according to an inference result of the machine learning model.
(N6) The user equipment of any one of (N1) to (N5),
   wherein the selection condition indicates a predicted link quality in a future time for a candidate beam of the plurality of candidate beams according to an inference result of the machine learning model.
(N7) The user equipment of any one of (N1) to (N6),
   wherein the selection condition indicates an associated priority for respective ones of the plurality of candidate beams.
(N8) the user equipment of (N7),
   wherein the associated priority is based on an inference result of the machine learning model.
(N9) The user equipment of (N7) or (N8),
   wherein the associated priority is based on a predicted link quality of the respective candidate beams within a certain time range.
(N10) The user equipment of any one of (N7) to (N9),
   wherein the associated priority is based on a link quality evolution trend of the respective candidate beams.
(N11) The user equipment of any one of (N7) to (N10),
   wherein the associated priority is based on service characteristics requirements of the user equipment.
(O1) A circuitry for a mobile telecommunications system, wherein the circuitry is configured to:
   obtain, from a machine learning model, candidate beam information for a user equipment of the mobile telecommunications system, wherein the candidate beam information indicates a plurality of candidate beams for beam failure recovery of the user equipment; and
   configure the plurality of candidate beams for the user equipment and a selection condition for selecting a candidate beam of the plurality of candidate beams for beam failure recovery.
(O2) The circuitry of (O1),
   wherein the selection condition indicates different respective beam quality thresholds for at least two candidate beams of the plurality of candidate beams according to an inference result of the machine learning model.
(O3) the circuitry of (O2),
   wherein the beam quality thresholds relate to a reference signal received power of the respective candidate beams.
(O4) The circuitry of any one of (O1) to (O3),
   wherein the circuitry is configured to transmit the candidate beam information to the user equipment.
(O5) The circuitry of any one of (O1) to (O4),
   wherein the selection condition indicates time information for a candidate beam of the plurality of candidate beams according to an inference result of the machine learning model.
(O6) The circuitry of any one of (O1) to (O5),
   wherein the selection condition indicates a predicted link quality in a future time for a candidate beam of the plurality of candidate beams according to an inference result of the machine learning model.
(O7) The circuitry of any one of (O1) to (O6),
   wherein the selection condition indicates an associated priority for respective ones of the plurality of candidate beams.
(O8) The circuitry of (O7),
   wherein the associated priority is based on an inference result of the machine learning model.
(O9) the circuitry of (O7) or (O8),
   wherein the associated priority is based on a predicted link quality of the respective candidate beams within a certain time range.
(O10) The circuitry of any one of (O7) to (O9),
   wherein the associated priority is based on a link quality evolution trend of the respective candidate beams.
(O11) the circuitry of any one of (O7) to (O10),
   wherein the associated priority is based on service characteristics requirements of the user equipment.
(P1) A method for a mobile telecommunications system, wherein the method comprises:
   obtaining, from a machine learning model, candidate beam information for a user equipment of the mobile telecommunications system, wherein the candidate beam information indicates a plurality of candidate beams for beam failure recovery of the user equipment; and
   configuring the plurality of candidate beams for the user equipment and a selection condition for selecting a candidate beam of the plurality of candidate beams for beam failure recovery.
(P2) the method of (P1),
   wherein the selection condition indicates different respective beam quality thresholds for at least two candidate beams of the plurality of candidate beams according to an inference result of the machine learning model.
(P3) The method of (P2),
   wherein the beam quality thresholds relate to a reference signal received power of the respective candidate beams.
(P4) the method of any one of (P1) to (P3),
   wherein the method comprises transmitting the candidate beam information to the user equipment.
(P5) The method of any one of (P1) to (P4),
   wherein the selection condition indicates time information for a candidate beam of the plurality of candidate beams according to an inference result of the machine learning model.
(P6) The method of any one of (P1) to (P5),
   wherein the selection condition indicates a predicted link quality in a future time for a candidate beam of the plurality of candidate beams according to an inference result of the machine learning model.
(P7) the method of any one of (P1) to (P6),
   wherein the selection condition indicates an associated priority for respective ones of the plurality of candidate beams.
(P8) the method of (P7),
   wherein the associated priority is based on an inference result of the machine learning model.
(P9) The method of (P7) or (P8),
   wherein the associated priority is based on a predicted link quality of the respective candidate beams within a certain time range.
(P10) The method of any one of (P7) to (P9),
   wherein the associated priority is based on a link quality evolution trend of the respective candidate beams.
(P11) The method of any one of (P7) to (P10),
   wherein the associated priority is based on service characteristics requirements of the user equipment.
(Q1) A method for a user equipment of a mobile telecommunications system, wherein the method comprises:
   obtaining, from a machine learning model, candidate beam information for the user equipment, wherein the candidate beam information indicates a plurality of candidate beams for beam failure recovery of the user equipment; and
   configuring the plurality of candidate beams for communication with a base station of the mobile telecommunication system and a selection condition for selecting a candidate beam of the plurality of candidate beams for beam failure recovery.
(Q2) the method of (Q1),
   wherein the selection condition indicates different respective beam quality thresholds for at least two candidate beams of the plurality of candidate beams according to an inference result of the machine learning model.
(Q3) The method of (Q2),
   wherein the beam quality thresholds relate to a reference signal received power of the respective candidate beams.
(Q4) the method of any one of (Q1) to (Q3),
   wherein the obtaining of the candidate beam information includes receiving the candidate beam information from the base station.
(Q5) the method of any one of (Q1) to (Q4),
   wherein the selection condition indicates time information for a candidate beam of the plurality of candidate beams according to an inference result of the machine learning model.
(Q6) The method of any one of (Q1) to (Q5),
   wherein the selection condition indicates a predicted link quality in a future time for a candidate beam of the plurality of candidate beams according to an inference result of the machine learning model.
(Q7) the method of any one of (Q1) to (Q6),
   wherein the selection condition indicates an associated priority for respective ones of the plurality of candidate beams.
(Q8) The method of (Q7),
   wherein the associated priority is based on an inference result of the machine learning model.
(Q9) the method of (Q7) or (Q8),
   wherein the associated priority is based on a predicted link quality of the respective candidate beams within a certain time range.
(Q10) The method of any one of (Q7) to (Q9),
   wherein the associated priority is based on a link quality evolution trend of the respective candidate beams.
(Q11) The method of any one of (Q7) to (Q10),
   wherein the associated priority is based on service characteristics requirements of the user equipment.
(R1) A computer program comprising program code causing a computer to perform the method according to anyone of (P1) to (Q11), when being carried out on a computer.
(R2) A non-transitory computer-readable recording medium that stores therein a computer program product, which, when executed by a processor, causes the method according to anyone of (P1) to (Q11) to be performed.

1. A base station for a mobile telecommunications system, wherein the base station comprises circuitry configured to:
obtain candidate beam information for a user equipment of the mobile telecommunications system, wherein the candidate beam information is generated by a machine learning model and indicates a candidate beam for beam level mobility of the user equipment; and
configure the candidate beam for communication with the user equipment according to the candidate beam information.

2. The base station of claim 1,
wherein the machine learning model is evaluated by the user equipment; and
wherein the obtaining of the candidate beam information includes receiving the candidate beam information from the user equipment.

3. The base station of claim 1,
wherein the machine learning model is evaluated on a network side of the mobile telecommunications system.

4. The base station of claim 3, wherein the circuitry is configured to:
receive a measurement report from the user equipment;
obtain the candidate beam information by generating, by the machine learning model, the candidate beam information based on the received measurement report; and
transmit to the user equipment a deactivation signal that instructs the user equipment to skip sending a measurement report.

5. The base station of claim 4,
wherein the deactivation signal is based on a physical layer signaling.

6. The base station of claim 4,
wherein the deactivation signal is included in Downlink Control Information.

7. The base station of claim 4,
wherein the circuitry is configured to transmit the deactivation signal if the circuitry decides that the received measurement report is sufficient for generating a future candidate beam information.

8. The base station of claim 4,
wherein the circuitry is configured to transmit the deactivation signal if a probability of a beam level switch of the user equipment is estimated to be low based on a mobility status of the user equipment.

9. The base station of claim 4,
wherein the circuitry is further configured to transmit to the user equipment an activation signal that instructs the user equipment to resume sending a measurement report.

10. The base station of claim 4,
wherein the measurement report indicates a reference signal received power of a physical channel on which the user equipment receives a beam.

11.19. (canceled)

20. A user equipment for a mobile telecommunications system, wherein the user equipment comprises circuitry configured to:
obtain candidate beam information for the user equipment, wherein the candidate beam information is generated by a machine learning model and indicates a candidate beam for beam level mobility of the user equipment; and
configure the candidate beam for communication with a base station of the mobile telecommunications system according to the candidate beam information,

21. The user equipment of claim 20,
wherein the obtaining of the candidate beam information includes evaluating the machine learning model.

22. The user equipment of claim 20,
wherein the machine learning model is evaluated on a network side of the mobile telecommunications system; and
wherein the obtaining of the candidate beam information includes receiving the candidate beam information from the base station.

23. The user equipment of claim 22, wherein the circuitry is configured to:
transmit a measurement report to the base station for generating the candidate beam information based on the measurement report;
receive from the base station a deactivation signal that instructs the user equipment to skip sending a measurement report; and
skip sending a measurement report according to the deactivation signal.

24. The user equipment of claim 23,
wherein the deactivation signal is based on a physical layer signaling.

25. The user equipment of claim 23,
wherein the deactivation signal is included in Downlink Control Information.

26. The user equipment of claim 23, wherein the circuitry is further configured to:
receive from the base station an activation signal that instructs the user equipment to resume sending a measurement report; and
resume sending a measurement report according to the activation signal.

27. The user equipment of claim 23,
wherein the measurement report indicates a reference signal received power of a physical channel on which the user equipment receives a beam.

28. The user equipment of claim 20,
wherein the configuring of the candidate beam includes configuring a switching condition for switching to the candidate beam.

29.-36.(canceled)

37. A circuitry for a mobile telecommunications system, wherein the circuitry is configured to:
obtain candidate beam information for a user equipment of the mobile telecommunications system, wherein the candidate beam information is generated by a machine learning model and indicates a candidate beam for beam level mobility of the user equipment; and
configure the candidate beam for communication with the user equipment according to the candidate beam information.

38.-154. (canceled)
